(19) United States
(12) Patent Application Publication
(10) Pub. No.: US 2022/0225601 A1
(43) Pub. Date: Jul. 21, 2022

(54) IMPROVED PEST CONTROL COMPOSITIONS USING VAPOR ACTIVITY

(71) Applicant: Terramera, Inc., Vancouver (CA)

(72) Inventors: Karan MANHAS, Vancouver (CA); Annett ROZEK, Vancouver (CA); Nathan WOODBURY, Vancouver (CA); Robert TAKEUCHI, Vancouver (CA)

(21) Appl. No.: 17/433,562

(22) PCT Filed: Feb. 26, 2020
(86) PCT No.: PCT/CA2020/050253

§ 371 Date: Aug. 24, 2021

Related U.S. Application Data
(60) Provisional application No. 62/811,146, filed on Feb. 27, 2019.
(60) Provisional application No. 62/980,552, filed on Feb. 24, 2020.

(51) Int. Cl. A01M 1/20

(52) U.S. Cl. CPC A01M 1/2022

(57) ABSTRACT

Devices and methods and pesticidal and/or pest control compositions are disclosed for the control of pests using the vapors of a pesticidal and/or pest control composition. Compositions, devices, methods and vapor forming pesticidal compositions which have improved vapor forming characteristics and are desirable under certain regulatory structures are also disclosed. In some non-limiting examples, the pests are arthropods or nematodes, and more particularly may include bed bugs, fleas, lice, ticks, or the like.

### REFERENCE TO RELATED APPLICATIONS

This application is related to U.S. patent application Ser. No. 15/037,513 filed May 18, 2016, PCT application PCT/IB2014/066139 filed Nov. 18, 2014, U.S. Provisional Patent Application Nos. 61/905,415; 61/911,434; 61/913,194; 61/918,641; 61/941,049; and 62/008,425, PCT application PCT/IB2012/055348, U.S. patent application Ser. No. 15/851,550, U.S. Provisional Patent Application No. 62/612,287, and U.S. Provisional Patent Application No. 62/811,146, each of which is herein incorporated by reference in their entirety as though they formed a part of this specification as filed.

### TECHNICAL FIELD

Some embodiments of the present invention pertain to compositions, substrates and/or devices that can be used to control a variety of pests. Some embodiments of the present invention can be used to control arthropods, including insects, mites and arachnids, such as for example, bed bugs, ticks, lice, flies, cockroaches, varroa mites, granary weevils, and/or other pests. Some embodiments of the present invention are compositions, substrates or devices that release vapors having pesticidal or pest control active and/or pest control and/or plant health activity. Some embodiments of the present invention pertain to compositions, methods or apparatus for selectively controlling an undesirable target pest, including an arthropod, while not harming or harming to a lesser extent than the undesirable pest a desirable organism, such as but not limited to including another arthropod. In some embodiments, the compositions, methods or apparatus are used to control household pests, to control parasitic infestations, and/or to treat foodstuffs and the like.

### BACKGROUND

Pest control remains an ongoing, worldwide problem. Lack of effective pesticides and/or effective methods of applying them has resulted in nearly epidemic growth of some pests. There is consistently increasing demand for safe, naturally-derived, effective pest control solutions to address these issues.

There are several problems with existing products. Conventional chemical pesticides are toxic or do not work well enough. Many insects have developed high levels of resistance to common conventional pesticides. Many conventional pesticides are being limited or phased out by governments. This has prompted a search for natural solutions, but traditional botanical biochemicals can be inconsistent, unstable, hard to deliver and only work on contact.

One particular challenge in controlling pests such as bed bugs and other arthropods is that the pests may harbor in areas that are difficult to treat or susceptible to damage by conventional liquid spray products and methods. For example, bed bugs are known to hide in any available cracks and crevices, including within books, electronics, frames, seams, etc., that cannot be effectively or safely treated by conventional sprays or dusts. These conventional pesticide products typically require direct contact between the pest and the pesticide in its solid or liquid form in order to be effective.

Examples of pests include all life-stages of insects of the orders Hemiptera, Blattodea, Hymenoptera, Siphonaptera, Coleoptera, Lepidoptera, Diptera, Thysanura, Psocoptera, Dermaptera, Orthoptera Thysanoptera, including pests that impact human health such as bed bugs (Cimex lectularius), kissing bugs (Triatoma spp., Paratriatoma spp.), cockroaches (Blattella spp., Periplaneta spp., Blatta spp., Supella spp.), ants (family Formicidae), and fleas (Ctenocephalides spp. Pulex spp., Xenopsylla spp.), as well as insect pests that invade human structures such as beetles (Sitophilus spp., Dermestes spp., Attagenus spp., Anthrenus spp., Trogoderma spp., Tenebrio spp.), moths (Tinea pellinella, Tineola bissellilella, Plodia spp.), flies (Drosophila spp., Calliphora spp., Phaenicia spp., Pollenia spp., Musca spp., Sarcophaga spp., Wohlfahrtia vigil, Psychoda spp., Telmatoscopus albipunctatus, Dohrniphora cornuta, Megaselia scalaris, family Sciaridae, family Mycetophilidae), stink bugs (Boisea trivattata), silverfish (Lepisma saccharina, Ctenolepisma longicaudata), firebrats (Thermobia domestica), booklice (Lachesilla pedicularia, Liposcscelis spp.), earwigs (Forficula auricularia, Emorellia annulipes, Labidura riparia), crickets (Acheta domesticus, Gryllus spp.), and the like. Examples of non-insect arthropod pests include all life stages of human body lice (Pediculus humanus, Pediculus humanus capitus, Pthirus pubis), ticks (Family Ixodidae), chiggers (Family Tromiculidae), human & vertebrate mites (Sarcoptes scabies, Ornithonyssus spp., Dermanyssus gallinae, Pyemotes tritici, invertebrate mites (Varroa destructor), and the like. Pests also include pests that can infest stored products (including for example foodstuffs), including almond moth (Cadra cautella), Angoumois grain moth (Sitotroga cerealella), carpet beetle (Dermestes maculatus), Cadelle (Tenebroides mauritanicus), cigarette beetle (Lasioderma serricorne), coffee bean weevil (Araecerus fasciculatus), confused flour beetle (Tribolium confusum), cowpea weevil (Callosobruchus maculatus), drugstore beetle (Stegobium paniceum), European grain moth (Nemopogon granella), flat grain beetle (Cryptolestes pusillus), grain mite (Acarus siro), granary weevil (Sitophilus granarius), Indian meal moth (Plodia interpunctella), Khapra beetle (Trogoderma granarium), larder beetle (Dermestes lardarius), lesser grain borer (Rhyzopertha dominica), maize weevil (Sitophilus zeamais), mealworm (Tenebrio molitor), Mediterranean flour moth (Anagasta kuehniella), merchant grain beetle (Oryzaephilus mercator), red flour beetle (Tribolium castaneum), rice moth (Corcyra cephalonica), rice weevil (Sitophilus oryzae), rusty grain beetle (Cryptolestes ferrugineus), sawtooth grain beetle (Oryzaephilus surinamensis), warehouse beetle (Trogoderma variable), and the like.

Another problem in controlling pests is that, while there are pests that are arthropods, there are also a number of beneficial species that are also arthropods. It may be desirable to control pest species of arthropods, while not harming, or at least harming to a lesser extent, a beneficial species of arthropod. One example of such a problem needing to be addressed is varroa mite infestations of honey bee colonies. Varroa mites are an external parasitic mite that attach to and feed on honey bees and are believed to be the largest contributing factor in the present decline of honey bee populations. A significant mite infestation may be a contributing factor to colony collapse disorder (CCD) and can lead to the death of a honey bee colony. This has a major economic impact on the beekeeping industry as well as a serious environmental impact due to the beneficial role bees play in the ecosystem. Varroa mites are smaller in size (i.e. have a lower mass) than honey bees. There is a need for improved compositions, methods and apparatus that can be used to control varroa mites without significantly harming honey bees.

There is a need for improved pest control products and methods that utilize vapor action to effectively and safely treat pests in a manner that addresses the drawbacks of existing treatments. Vapors have the advantage of dispersing evenly throughout a given volume of space, including penetrating into small and hidden spaces that would be difficult or impossible to reach otherwise. Vapors allow the maximum and most even penetration within a volume of space of a given mass of a pesticide. Gas phase vapors also have the advantage of not adversely affecting many types of materials such as electronics, books, or other valuable items, that can be damaged by application of a liquid (e.g. short-circuiting, warping, staining, etc.), or adversely affecting such materials to a lesser extent than a liquid.

One disadvantage of some pesticidal or pest control active compounds, including botanical oils such as neem oil for example, is that when used alone, they may typically have low volatility and do not release effective quantities of pesticidal or pest control active vapors for efficacy. There remains a need for compositions and methods that improve the volatilization of pesticidal or pest control active compounds and/or otherwise allow for the release of vapors having effective pesticidal or pest control active activity. However, some vapor compositions may comprise vapor active components which may be at least one of undesirably toxic, noxious, ozone-depleting, unstable, or prohibited from use by government, industry, or other regulations or requirements, which may desirably or necessarily limit their application in vapor compositions. Accordingly, there remains a need for improved vapor pest control compositions, devices and methods.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In some embodiments, one or more of the above-described problems have desirably been reduced or eliminated, while other embodiments are directed to other improvements.

In some embodiments, devices and methods are provided for controlling pests using pesticidal or pest control active vapors. In some embodiments the pests can be terrestrial arthropods, including subterranean arthropods. In some embodiments, an arthropod pest is controlled while a beneficial species, which in some embodiments may also be an arthropod, is not harmed, or is harmed to a lesser extent, by the pesticidal or pest control active vapors. In some such embodiments, the pest comprises varroa mites and the beneficial species comprises honey bees.

In some embodiments, a pesticidal composition is provided comprising at least: a pesticidal active ingredient, a polar aromatic solvent, and at least one vapor forming carrier component, wherein the pesticidal composition is adapted to release pesticidal vapors comprising said pesticidal active ingredient. In some particular such embodiments, the pesticidal active ingredient comprises at least one of a synthetic and a natural pesticidal active ingredient. In some further embodiments, the pesticidal active ingredient comprises at least one pesticidal oil such as a natural pesticidal oil. In some other embodiments, the pesticidal composition additionally comprises a surfactant or emulsifier. In some exemplary embodiments, the pesticidal active ingredient may additionally comprise at least one plant health active ingredient. In some further embodiments, the pesticidal active ingredient comprises neem oil.

In some embodiments, the polar aromatic solvent comprises at least one of an aryl ketone, and an aryl alcohol. In some particular such embodiments, the polar aromatic solvent comprises at least one of an aryl-aryl ketone, and aryl-alkyl ketone, an aryl-aryl alcohol, an aryl-alkyl alcohol, an aryl alcohol, an aryl carboxylic acid, an aryl ester, an aryl-alkyl ester, an aryl-aryl ester, an aryl-alkyl ether, an aryl-aryl ether, and/or combinations thereof.

In some embodiments, the pesticidal active ingredient comprises one or more pesticidal natural oil. In some such embodiments, the pesticidal natural oil comprises neem oil or derivatives thereof. In other embodiments, the pesticidal natural oil comprises neem oil, clove oil, peppermint oil, cinnamon oil, thyme oil, oregano oil, garlic oil, anise oil, geranium oil, lime oil, lavender oil, components or derivatives thereof—including for example geraniol derived from geranium oil and eugenol derived from clove oil—or a combination of the foregoing.

In some embodiments, the pesticidal natural oil comprises at least one pesticidal natural or essential oil, for example, neem oil. In some embodiments, the pesticidal natural oil may comprise one or more of: neem oil, karanja oil, clove oil, peppermint oil, mint oil, cinnamon oil, thyme oil, oregano oil, geranium oil, lime oil, lavender oil, anise oil, and/or garlic oil and/or components, derivatives and/or extracts of one or more pesticidal natural oil, or a combination of the foregoing, for example. In some embodiments, the pesticidal natural oil is neem oil or a component or derivative thereof. In another embodiment, the pesticidal natural oil comprises karanja oil or a component or derivative thereof. In another embodiment, the pesticidal natural oil comprises thyme oil or a component or derivative thereof.

In other embodiments, the pesticidal natural oil may comprise any natural oil or oil mixture that includes one or more constituents common to two or more of the pesticidal natural oils listed above (i.e. neem oil, karanja oil, clove oil, peppermint oil, cinnamon oil, thyme oil, oregano oil, garlic oil, anise oil, geranium oil, lime oil, lavender oil), including, but not limited to, thymol (found in oregano oil and thyme oil), p-cymene (found in oregano oil and thyme oil), 1,8-cineole (found in thyme oil and peppermint oil), eugenol (found in clove oil and cinnamon oil), limonene (found in cinnamon, peppermint, and lime oil), alpha-pinene (found in cinnamon oil, geranium oil, and lime oil), carvacrol (found in oregano oil, thyme oil, and clove oil), gamma-terpinene (found in oregano oil and lime oil), geraniol (found in thyme oil and geranium oil), alpha-Terpineol (found in thyme oil and anise oil), beta-caryophyllene (found in clove oil, cinnamon oil, and peppermint oil) and linalool (found in thyme oil, cinnamon oil and geranium oil, amongst others). In other embodiments, the pesticidal natural oil may comprise any oil having as a constituent one of the following compounds, or a combination of the following compounds: azadirachtin, nimbin, nimbinin, salannin, gedunin, geraniol, geranial, gamma-terpinene, alpha-terpineol, beta-caryophyllene, terpinen-4-ol, myrcenol-8, thuyanol-4, benzyl alcohol, cinnamaldehyde, cinnamyl acetate, alpha-pinene, geranyl acetate, citronellol, citronellyl formate, isomenthone, 10-epi-gamma-eudesmol, 1,5-dimethyl-1-vinyl-4-hexenylbutyrate, 1,3,7-octatriene, eucalyptol, camphor, diallyl disulfide, methyl allyl trisulfide, 3-vinyl-4H-1,2 dithiin, 3-vinyl-1,2 dithiole-5-cyclohexane, diallyl trisulfide, anethole, methyl chavicol, anisaldehyde, estragole, linalyl acetate, geranial, beta-pinene, thymol, carvacrol, p-cymene, beta-myrcene, alpha-myrcene, 1,8-cineole, eugenol, limonene, alpha-pinene, menthol, menthone, and linalool.

In further embodiments, the pesticidal natural oil may comprise one or more suitable plant essential oils or extracts or fractions thereof disclosed herein including, without limitation: alpha- or beta-pinene; alpha-campholenic aldehyde; alpha.-citronellol; alpha-iso-amyl-cinnamic (e.g., amyl cinnamic aldehyde); alpha-pinene oxide; alpha-cinnamic terpinene; alpha-terpineol (e.g., 1-methyl-4-isopropyl-1-cyclohexen-8-ol); lamda-terpinene; achillea; aldehyde C16 (pure); allicin; alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; calamus; camphor; cananga oil (e.g., java); cardamom; carnation (e.g., Dianthus caryophyllus); carvacrol; carveol; cassia; castor; cedar (e.g., hinoki); cedarwood; chamomile; cineole; cinnamaldehyde; cinnamic alcohol; cinnamon; cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; d-dihydrocarvone; decyl aldehyde; diallyl disulfide; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; Ferniol™; fish; florazon (e.g., 4-ethyl-.alpha., .alpha.-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl) bicyclo(2,2,1) hept-5-ene-2-carboxylic acid ethyl ester); hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalyl acetate; linseed; litsea cubeba; I-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., Myristica fragrans); orange (e.g., Citrus aurantium dulcis); orris (e.g., iris florentina) root; para-cymene; para-hydroxy phenyl butanone crystals (e.g., 4-(4-hydroxphenyl)-2-butanone); passion palmarosa oil (e.g., cymbopogon martini); patchouli (e.g., Pogostemon cablin); p-cymene; pennyroyal oil; pepper; peppermint (e.g., Mentha piperita); perillaldehyde; petitgrain (e.g., Citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary (e.g., Rosmarinus officinalis); ryu; sage; sandalwood (e.g., santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; wintergreen (methyl salicylate) oils, and the like.

In some embodiments, the at least one vapor forming carrier component may comprise one or more of methyl acetate, ethyl acetate, tert butyl acetate, benzyl alcohol, dibasic ester, dimethyl glutarate, acetone, acetophenone, parachlorobenzotrifluoride, isopropanol, ammonium carbonate, methanol, Zemasol™ and combinations thereof. In some embodiments, the pesticidal composition may comprise at least one vapor forming carrier selected from suitable such compounds which are also exempt from regulation as a volatile organic compound (VOC) by at least one regulatory agency or body, for example. In some further embodiments, the pesticidal composition may comprise at least one vapor forming carrier selected from suitable such compounds which are also listed by the US Environmental Protection Agency (EPA) as a Minimal Risk Inert Pesticide Ingredient (4A) (the list of ingredients published dated December 2015 by the US EPA FIFRA 4a list published August 2004 entitled “List 4A—Minimal Risk Inert Ingredients”) or, for example, as an Inert Pesticide Ingredient (4B) (the US EPA FIFRA 4b list published August 2004 entitled “List 4B—Other ingredients for which EPA has sufficient information”) or under EPA regulation 40 CFR 180.950 dated May 24, 2002, each of which is hereby incorporated herein in its entirety for all purposes. In some further embodiments, the pesticidal composition may comprise at least one vapor forming carrier selected from suitable such compounds which are also listed as allowable or minimal risk ingredients permitted by another regulatory body or agency, such as a regulatory body or agency which regulates pesticidal compositions, for example.

In some embodiments, the pesticidal composition may additionally comprise at least one emulsifier or other surfactant used in preparing pesticidal compositions according to aspects of the present disclosure. In some such embodiments, suitable surfactants can be selected by one skilled in the art. Examples of surfactants that can be used in some embodiments of the present disclosure may comprise or include, but are not limited to: sodium lauryl sulfate, saponin, ethoxylated alcohols, ethoxylated fatty esters, alkoxylated glycols, ethoxylated fatty acids, ethoxylated castor oil, glyceryl oleates, carboxylated alcohols, carboxylic acids, fatty acids, ethoxylated alkylphenols, fatty esters, sodium dodecylsulfide, other fatty acid-based surfactants, other natural or synthetic surfactants, and combinations thereof. In some embodiments, the surfactant(s) are non-ionic surfactants. In some embodiments, the surfactant(s) are cationic or anionic surfactants. In some embodiments, a surfactant may comprise two or more surface active agents used in combination. The selection of an appropriate surfactant depends upon the relevant applications and conditions of use, and selection of appropriate surfactants are known to those skilled in the art.

In one aspect, a pesticidal composition according to some embodiments of the present disclosure may additionally comprise one or more diluent component. Such additional diluent component can be selected by one skilled in the art, depending on the particular application desired and the conditions of use of the composition. Commonly used additional diluents may include ethanol, isopropanol, propylene glycol, water and other inert diluents, such as but not limited to suitable inert diluents listed by the EPA as a Minimal Risk Inert Pesticide Ingredients (4A) (the list of ingredients published dated December 2015 by the US EPA FIFRA 4a list published August 2004 entitled “List 4A—Minimal Risk Inert Ingredients”) or, for example, Inert Pesticide Ingredients (4B) (the US EPA FIFRA 4b list published August 2004 entitled “List 4B—Other ingredients for which EPA has sufficient information”) or under EPA regulation 40 CFR 180.950 dated May 24, 2002, each of which is hereby incorporated herein in its entirety for all purposes. In some embodiments, the pesticidal composition may additionally comprise one or more of additional insect controlling compounds and/or additional natural oils or other products to add fragrance, increase or decrease repellency, or extend the range of pests susceptible to the composition, for example.

In some embodiments, the pesticidal composition may comprise a pesticidal natural oil at a concentration of between 0.25% and 25% by weight, including any concentration therebetween e.g. 0.3%, 0.4%, 0.5%, 0.6%, 0.7%, 0.8%, 0.9%, 1%, 2%, 2.5%, 3%, 3.5%, 4%, 4.5%, 5%, 5.5%, 6%, 6.5%, 7%, 7.5%, 8%, 8.5%, 9%, 9.5%, 10%, 12.5%, 15%, 17.5%, 20%, 22.5%, 25% by weight, or any other concentration therebetween, a polar aromatic solvent at a concentration between 0.7% and 72% by weight, including any concentration therebetween e.g. 0.8%, 0.9%, 1.0%, 1.2%, 1.4%, 1.6%, 1.8%, 2%, 3%, 4%, 5%, 6%, 6.5%, 7%, 7.5%, 10%, 12.5%, 15%, 17.5%, 18.25%, 20%, 25%, 30%, 35%, 40%, 45%, 50%, 55%, 60%, 65%, 70%, 72% by weight, or any other concentration therebetween. In some embodiments, the polar aromatic solvent is present at a concentration between 0.13 mol/kg and 8.3 mol/kg or any value therebetween, e.g. 0.2, 0.4, 0.6, 0.8, 1.0, 1.5, 2.0, 2.5, 3.0, 3.5, 4.0, 4.5, 5.0, 5.5, 6.0, 6.5, 7.0, 7.5, or 8.0 mol/kg. In some embodiments, a pesticidal composition is provided in which the weight ratio of polar aromatic solvent to pesticidal natural oil is in the range of 0.9:1 to 7:1, or any range therebetween including e.g. 0.9:1, 1:1. 1.5:1, 2:1, 2.5:1, 3:1, 4:1, 5:1, or 6:1.

In some other embodiments, a pesticidal composition comprises at least one natural pesticidal oil, at least one surfactant, and at least one vapor forming carrier. In one such embodiment, the pesticidal composition comprises neem oil, an ethoxylated castor oil surfactant, and at least one vapor forming carrier component selected from the list comprising methyl acetate, ethyl acetate, tert butyl acetate, benzyl alcohol, dibasic ester, dimethyl glutarate, acetone, acetophenone, parachlorobenzotrifluoride, isopropanol, ammonium carbonate, methanol, Zemasol™, and combinations thereof. In one such embodiment, the pesticidal composition comprises neem oil or a component or derivative thereof, ethoxylated castor oil, and at least one of methyl acetate and ethyl acetate, and is effective to produce pesticidal vapors comprising neem oil or a component or derivative thereof. In a particular such embodiment, the pesticidal composition comprises by weight 2.5-7.5% neem oil, 1-2% ethoxylated castor oil, 35-75% methyl or ethyl acetate, and the balance of a suitable inert diluent.

In some further embodiments, a pesticidal composition is provided comprising at least: a pesticidal active ingredient, a surfactant or emulsifier, and at least one vapor forming carrier component, and at least one diluent, wherein the pesticidal composition is adapted to release pesticidal vapors comprising said pesticidal active ingredient. In some particular such embodiments, the pesticidal active ingredient comprises at least one of a synthetic and a natural pesticidal active ingredient. In some further embodiments, the pesticidal active ingredient comprises at least one pesticidal oil. In some exemplary embodiments, the pesticidal active ingredient may additionally comprise at least one plant health active ingredient. In some further embodiments, the pesticidal active ingredient comprises neem oil.

In some embodiments, pesticidal or pest control active vapors are released from a substrate impregnated with a pesticidal or pest control active composition, from a gel comprising a pesticidal or pest control active composition, and/or from a device for releasing pesticidal or pest control active vapors, including from a liquid pesticidal or pest control active composition.

In some embodiments, a pest control device is provided, having a housing with a reservoir for containing a pesticidal composition, and a mechanism for releasing vapors of the pesticidal composition. In some embodiments, the device is or has a substrate impregnated with a pesticidal composition. The substrate can be a naturally occurring polymer or a synthetic polymer. In some embodiments, the substrate is cotton, paper, or a porous plastic made from polyethylene or polyester fibres, and may optionally comprise multiple layers thereof. In some embodiments, the release of vapors by the device is enhanced by an active release mechanism. In some embodiments, an indicator is provided to provide a visual indication of the amount of pesticidal composition remaining in the device.

In some embodiments, a source of pesticidal vapors is placed in a treatment enclosure containing pests or articles infested or thought to be infested with pests. In some embodiments, the source of pesticidal vapors is integrated with or provided as an integral component of the treatment enclosure. In some embodiments, the source of pesticidal vapors is enclosed within the treatment enclosure for a period of time sufficient to control pests within the treatment enclosure. In some embodiments, the supply of pesticidal composition to the substrate is periodically or continuously replenished to continue production of pesticidal vapors over a period of time, for example by pumping additional pesticidal composition to the substrate. In some embodiments, the pesticidal composition is supplied to a device for releasing pesticidal vapors as a self-contained puck, and the puck is periodically exchanged for a fresh puck.

In some further embodiments of the present invention, pesticidal materials may desirably further comprise one or more plant health active compound, such as may be used to enhance or treat a plant health condition of a plant, or to stimulate an immune, metabolic, genetic or other mechanism or systemic function of one or more plants so as to improve, stimulate, enhance, strengthen, or otherwise influence plant health characteristics of a plant, for example.

Aspects of the present disclosure provide a device for releasing vapors of at least one of a pesticidal and a pest control composition. The device comprises a substrate impregnated with the composition, the composition comprising at least one pesticidal or pest control active ingredient, a surfactant or emulsifier, and a vapor forming carrier component, said composition being effective to form pesticidal or pest control vapors comprising said at least one pesticidal or pest control active ingredient; an impermeable housing containing the substrate, the housing comprising one or more apertures adapted for releasing vapors from the substrate; and a seal non-adhesively and removably bonded to the impermeable housing to control release of vapors by the apertures.

In some embodiments, the seal is bonded to the housing by a heat-sealed bond. In some embodiments, the seal and at least a portion of the housing are integrally formed. In some embodiments, the seal is peelably removable from the housing. In some embodiments, the composition is heavier than air and the housing defines the apertures on non-coplanar surfaces of the housing. In some embodiments, the housing comprises first and second portions, the first and second portions non-adhesively bonded together.

In some embodiments, the device comprises: one or more supports for supporting the substrate, the one or more supports configured to position the substrate to define an opening for delivery of the composition; and a deflection surface for deflecting the composition during delivery after passing through the opening, the deflection surface configured to deflect the composition toward the substrate. In some embodiments, the deflection surface comprises a wedge shape having a forward edge oriented toward the opening. In some embodiments, at least one of the support and the deflection surface is integrally formed with the housing.

In some embodiments, said vapor forming carrier component comprises at least one component selected from the list comprising: methyl acetate, ethyl acetate, tert butyl acetate, benzyl alcohol, dibasic ester, dimethyl glutarate, acetone, acetophenone, parachlorobenzotrifluoride, ammonium carbonate, methanol, Zemasol™ and combinations thereof.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an exemplary impregnated substrate with an impermeable backing in accordance with one embodiment of the present disclosure.

FIG. 2 shows an exemplary impregnated substrate with an adhesive backing in accordance with another embodiment of the present disclosure.

FIG. 3 shows an exemplary package of impermeable substrates with a resealable closure in accordance with a further embodiment of the present disclosure.

FIG. 4 shows a top view of a pillow-packaged substrate treatment pad device, showing a protective peel-off strip sealing over one or more vapor release apertures, and enclosing a substrate adapted for absorption of a pesticidal or pest control active formulation, according to an embodiment of the present disclosure.

FIG. 5 shows a top view of a pillow-packaged substrate treatment pad device after opening by removing a protective peel-off strip, showing an exemplary pattern of vapor release apertures, and enclosing a substrate adapted for absorption of a pesticidal or pest control active formulation for release of pesticidal or pest control active vapors through the apertures, according to an embodiment of the present disclosure.

FIG. 6 shows a top view of an alternative pillow-packaged substrate treatment pad device, showing visual elements and an instructive indicia for opening of a protective peel-off strip sealing over one or more vapor release apertures, for enclosing a substrate adapted for absorption of a pesticidal or pest control active formulation, according to an embodiment of the present disclosure.

FIG. 7 shows a top view of a pillow-packaged substrate treatment pad device, showing visual elements and an instructive indicia for opening of a top protective peel-off strip sealing over one or more vapor release apertures, and enclosing a substrate adapted for absorption of a pesticidal or pest control active formulation, according to an embodiment of the present disclosure.

FIG. 8 shows a top view of the pillow-packaged substrate treatment pad device shown in FIG. 40, showing the top protective peel-off strip partially removed to show one or more vapor release apertures, and enclosing a substrate adapted for absorption of a pesticidal or pest control active formulation and for release of pesticidal or pest control active vapors through the apertures, according to an embodiment of the present disclosure.

FIG. 9 shows a top view of a pillow-packaged substrate treatment pad device after opening by removing a protective peel-off strip, showing a pattern of vapor release apertures, and enclosing a substrate adapted for absorption of a pesticidal or pest control active formulation for release of pesticidal or pest control active vapors through the apertures, according to an embodiment of the present disclosure.

FIG. 10 shows a perspective view of a pillow-packaged substrate treatment pad device, showing the side and top of the pad after opening by removing a protective peel-off strip, showing a pattern of vapor release apertures, and enclosing a substrate adapted for absorption of a pesticidal or pest control active formulation for release of pesticidal or pest control active vapors through the apertures, according to an embodiment of the present disclosure.

FIG. 11 shows a side view of a pillow-packaged substrate treatment pad device after opening by removing a protective peel-off strip, showing a pattern of vapor release apertures, and enclosing a substrate adapted for absorption of a pesticidal or pest control active formulation for release of pesticidal or pest control active vapors through the apertures, according to an embodiment of the present disclosure.

FIG. 12 shows a bottom view of a pillow-packaged substrate treatment pad device, adapted for enclosing a substrate adapted for absorption of a pesticidal or pest control active formulation, according to an embodiment of the present disclosure.

FIG. 13 shows a top view of an alternative pillow-packaged substrate treatment pad device, showing visual elements and an instructive indicia for opening of a top protective peel-off strip sealing over one or more vapor release apertures, and enclosing a substrate adapted for absorption of a pesticidal or pest control active formulation, according to an embodiment of the present disclosure.

FIG. 14a shows schematically an exemplary bag with integrated pesticide-impregnated substrate, according to one embodiment of the present disclosure.

FIG. 14b shows schematically an exemplary multi-layer bag with a pesticidal or pest control active composition impregnated substrate membrane, according to one embodiment of the present disclosure.

FIG. 14c shows an exemplary reusable treatment enclosure with an external enclosure for receiving a source of pesticidal or pest control active vapors, according to one embodiment of the present disclosure.

FIG. 14d shows an exemplary single layer bag with a pesticidal or pest control active composition impregnated therein, according to one embodiment of the present disclosure.

FIG. 15 shows an exploded isometric view of an exemplary rigid package with a non-adhesive peelable label and a pesticidal or pest control active composition impregnated substrate, according to one embodiment of the present disclosure.

FIG. 16 shows an isometric view of the exemplary rigid package of FIG. 15 while the package is sealed.

FIG. 17 shows an isometric view of the exemplary rigid package of FIG. 15 while the package is unsealed.

FIG. 18 shows an isometric view of a plurality of exemplary rigid packages of FIG. 15 stacked together.

FIG. 19 shows a cross-sectional schematic view of the exemplary rigid package of FIG. 15 while being dosed with a pesticidal or pest control active composition.

FIG. 20 shows adult bed bug mortality on mattresses after 48 hours of exposure to certain solutions inside a sealed mattress bag.

FIG. 21 shows bed bug egg mortality on mattresses after 48 hours of exposure to certain solutions inside a sealed mattress bag.

FIG. 22 shows adult dust mite mortality on mattresses after 48 hours of exposure to certain solutions inside a sealed mattress bag.

FIG. 23 shows dust mite egg mortality on mattresses after 48 hours of exposure to certain solutions inside a sealed mattress bag.

FIG. 24 shows adult bed bug mortality after 48 hours of exposure to vapor emitted by an exemplary solution inside garbage bags filled with various items.

FIG. 25 shows bed bug egg mortality after 48 hours of exposure to vapor emitted by an exemplary solution inside garbage bags filled with various items.

FIG. 26 shows adult dust mite mortality after 48 hours of exposure to vapor emitted by an exemplary solution inside garbage bags filled with various items.

FIG. 27 shows dust mite egg mortality after 48 hours of exposure to vapor emitted by an exemplary solution inside garbage bags filled with various items.

FIG. 28 shows adult bed bug mortality after 5-day exposure to vapors emitted from certain formulations inside a bag filled with books.

FIG. 29 shows bed bug egg mortality after 5 days of exposure to vapors emitted from certain formulations inside a bag filled with books.

FIG. 30 shows adult bed bug mortality after 5 days of exposure to vapors emitted from certain formulations inside a bag filled with books.

FIG. 31 shows bed bug egg mortality after 5 days of exposure to vapors emitted from certain formulations inside a bag filled with books.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### Definitions

Unless defined otherwise, all technical and scientific terms used herein have the same meaning as commonly understood by one of ordinary skill in the art to which this invention belongs.

As used herein, singular forms include plural references unless the context clearly dictates otherwise. As used herein, “comprises” or “comprising” are to be interpreted in their open-ended sense, i.e. as specifying that the stated features, elements, steps or components referred to are present, but not excluding the presence or addition of further features, elements, steps or components.

As used herein, the term “pest” refers to organisms that negatively affect a host or other organism—such as a plant or an animal such as a mammal—by colonizing, damaging, attacking, competing with them for nutrients, or infecting them, as well as undesired organisms that infest human structures, dwellings, living spaces or foodstuffs. Pests can include arthropods, including insects, arachnids and cockroaches, and includes sucking, biting and stinging pests such as bed bugs, kissing bugs, mites, ticks, ants, lice, fleas, chiggers, biting flies, mosquitoes, and wasps, as well as insects that infest stored products such as moths, mites and weevils. Pests can further comprise any other organism which may negatively affect a host organism, such as but not limited to fungi, bacteria, viruses, molluscs, acari, nematodes and protozoa, for example.

Exemplary pests against which some embodiments can be used include terrestrial arthropods (including subterranean arthropods), including all life-stages of insects of the orders Hemiptera, Blattodea, Hymenoptera, Siphonaptera, Coleoptera, Lepidoptera, Diptera, Thysanura, Psocoptera, Dermaptera, Orthoptera Thysanoptera, including pests that impact human health such as bed bugs (Cimex lectularius), kissing bugs (Triatoma spp., Paratriatoma spp.), cockroaches (Blattella spp., Periplaneta spp., Blatta spp., Supella spp.), ants (family Formicidae), and fleas (Ctenocephalides spp. Pulex spp., Xenopsylla spp.), as well as insect pests that invade human structures such as beetles (Sitophilus spp., Dermestes spp., Attagenus spp., Anthrenus spp., Trogoderma spp., Tenebrio spp.), moths (Tinea pellinella, Tineola bissellilella, Plodia spp.), flies (Drosophila spp., Calliphora spp., Phaenicia spp., Pollenia spp., Musca spp., Sarcophaga spp., Wohlfahrtia vigil, Psychoda spp., Telmatoscopus albipunctatus, Dohrniphora cornuta, Megaselia scalaris, family Sciaridae, family Mycetophilidae), stink bugs (Boisea trivattata), silverfish (Lepisma saccharina, Ctenolepisma longicaudata), firebrats (Thermobia domestica), booklice (Lachesilla pedicularia, Liposcscelis spp.), earwigs (Forficula auricularia, Emorellia annulipes, Labidura riparia), crickets (Acheta domesticus, Gryllus spp.), and the like. Examples of non-insect arthropod pests include all life stages of human body lice (Pediculus humanus, Pediculus humanus capitus, Pthirus pubis), ticks (Family Ixodidae), chiggers (Family Tromiculidae), human & vertebrate mites (Sarcoptes scabies, Ornithonyssus spp., Dermanyssus gallinae, Pyemotes tritici, invertebrate mites (Varroa destructor), and the like. Pests also include pests that can infest stored products, including almond moth (Cadra cautella), Angoumois grain moth (Sitotroga cerealella), carpet beetle (Dermestes maculatus), Cadelle (Tenebroides mauritanicus), cigarette beetle (Lasioderma serricorne), coffee bean weevil (Araecerus fasciculatus), confused flour beetle (Tribolium confusum), cowpea weevil (Callosobruchus maculatus), drugstore beetle (Stegobium paniceum), European grain moth (Nemopogon granella), flat grain beetle (Cryptolestes pusillus), grain mite (Acarus siro), granary weevil (Sitophilus granarius), Indian meal moth (Plodia interpunctella), Khapra beetle (Trogoderma granarium), larder beetle (Dermestes lardarius), lesser grain borer (Rhyzopertha dominica), maize weevil (Sitophilus zeamais), mealworm (Tenebrio molitor), Mediterranean flour moth (Anagasta kuehniella), merchant grain beetle (Oryzaephilus mercator), red flour beetle (Tribolium castaneum), rice moth (Corcyra cephalonica), rice weevil (Sitophilus oryzae), rusty grain beetle (Cryptolestes ferrugineus), sawtooth grain beetle (Oryzaephilus surinamensis), warehouse beetle (Trogoderma variable), and the like.

As used herein, the term “vapor” has the meaning as defined by the Merriam Webster dictionary, of a “substance that is in the form of a gas or that consists of very small drops or particles mixed with the air.” Examples of vapors include, without limitation, gases, aerosols, mist, smoke, steam, fog, fumes and fumigants.

As used herein, the term “substrate” refers to any substance that contains or is impregnated with a pesticidal or pest control active composition. The substrate provides a medium for absorbing a liquid pesticidal or pest control active composition and releasing vapors of the pesticidal or pest control active composition.

As used herein, the term “gel” refers to a solid or semi-solid material having a substantially dilute cross-linked system, which exhibits no flow when in the steady-state.

As used herein, the term “liquid” refers to a substance that has a definite volume but no fixed shape. The “viscosity” of a liquid refers to the resistance of a liquid to gradual deformation by shear stress or tensile stress. A liquid with a higher viscosity is a relatively thicker (slower flowing) liquid.

As used herein, the term “diffuse” or “diffusion” refers to the spreading out of a substance through a volume of space, generally from regions of high concentration to regions of lower concentration. “Passive diffusion” refers to naturally occurring diffusion of a gas or aerosol unaided or influenced by application of an outside force, whereas “active diffusion” refers to diffusion that is aided or facilitated or influenced by the application of an outside force, agent or device.

As used herein, the term “phoretic mites” means mites living on adult bees, outside of the brood cells where the bees matured.

As used herein, the terms “control” or “controlling” include, but are not limited to, any killing, growth regulating, signaling or communication interruption, disruption or alteration, knockdown or pestistatic (inhibiting or otherwise interfering with the normal life cycle of the pest) activities of a composition against a given pest. These terms include for example sterilizing activities which prevent the production of ova or sperm, cause death of sperm or ova, or otherwise cause severe injury to the genetic material. Further activities intended to be encompassed within the scope of the terms “control” or “controlling” include preventing larvae from developing into mature progeny, modulating the emergence of pests from eggs including preventing eclosion, degrading the egg material, suffocation, reducing gut motility, inhibiting the formation of chitin, disrupting mating or sexual communication, and preventing feeding (antifeedant) activity. “Knockdown” is the inability of an arthropod to make coordinated movement, which eliminates its ability to locate food, shelter and/or host organisms.

### Pesticidal or Pest Control Active Compositions

Some embodiments of the present invention provide pesticidal or pest control active compositions that release vapors (via evaporation, aerosolization, etc.) having effective pesticidal or pest control active activity against pests and their eggs. Some embodiments provide substrates impregnated with a pesticidal or pest control active composition such that the substrate releases pesticidal or pest control active vapors over time. Some embodiments provide devices comprising a liquid or gelled pesticidal or pest control active composition or a substrate impregnated with a pesticidal or pest control active composition, wherein the device actively or passively diffuses pesticidal or pest control active vapors.

In some embodiments, the pesticidal or pest control active composition is applied in liquid form to a substrate such that the substrate contains, absorbs or is impregnated with the pesticidal or pest control active composition and serves as a vehicle for release of the pesticidal or pest control active composition in vapor form. Examples of such substrates include any kind of cloth, paper, textile, wipe, pad, sponge, mat, filter, honeycomb, or other porous or absorbent material. In some alternative embodiments, the substrate may comprise a container, ampoule, frangible reservoir, or other vessel or chamber which may contain a pesticidal or pest control active composition, and is adapted to release the composition in vapor form, such as by breaking, fracturing, tearing, crushing, bending, rupturing, puncturing, perforating or otherwise opening or venting the vessel or chamber so as to release the composition in vapor form, for example.

In some example embodiments, the substrate comprises a naturally occurring polymer, such as cellulose (for example in the form of cotton, paper, wood, wood pulp, or the like), wool, felt, chitin, silk or the like. Natural plant fibers can also be ‘manufactured’ into an artificial material where they are processed into pulp and then extruded like synthetic fibers like polyethylene, polyester or nylon to produce an artificial fiber like rayon or viscose, and these materials can be used as substrates in some example embodiments.

In some embodiments, the substrate is non-woven, for example, cotton batting and filter paper are examples of non-woven cellulose substrates. In some embodiments, the substrate is woven, for example, cotton cloth, wool or silk are examples of a woven cellulose substrates.

As used herein, a “woven” substrate refers to a substrate formed by weaving or knitting fibers together. The fibers can be synthetic (e.g. polyester or polypropylene) or natural (e.g. plant-derived like pulp or cotton or animal derived like wool or silk).

As used herein, a “non-woven” substrate is a substrate that is not woven. In some cases, naturally-occurring non-woven substrates will be produced naturally or with some human processing, for example in the case of cotton and paper. In some cases, fabric-like materials can be made through processing techniques that do not result in the formation of a woven substrate, and hence are non-woven, for example, some fabric-like materials are made from long fibers bonded together by chemical, mechanical, heat or solvent treatments, for example felt.

In some example embodiments, the substrate is a synthetic polymer, such as polyester, copolyester, cellulose acetate, olefins, nylon, modacrylate, polyphenylene sulfide, rayon, nylon, polypropylene, polyethylene, polybutylene terephthalate, polyurethanes, acrylic polymers, latex, styrene/butadiene, a silicone, or the like. In some embodiments, the synthetic polymer is woven. In some embodiments, the synthetic polymer is non-woven.

In some example embodiments, the substrate is a non-woven synthetic material, such as polyester, copolyester, cellulose acetate, olefins, nylon, modacrylate, polyphenylene sulfide, viscose, rayon, or the like. In some example embodiments, the substrate is a woven synthetic polymer, for example, polyester, nylon, polypropylene, polyethylene, or the like.

In some embodiments, the synthetic material can be partly or fully biodegradable.

In some embodiments, the substrate is a sponge. In some embodiments, the sponge is made from a synthetic material, for example, a foamed plastic polymer, a low density polyether, polyvinyl acetate (PVA), silicone or polyurethane foam, polyester, or the like. In some embodiments, the sponge is manufactured from a naturally occurring material such as cellulose, including cellulose obtained from wood.

In some embodiments, the substrate is a natural or manufactured cellulose material. In some embodiments, the natural cellulose material is in granular form, for example, corncob, wood, wood pulp, nut shells, chips, bark or the like.

In some embodiments, the substrate is a mineral, such as zeolite, diatomaceous earth, clay, sepiolite, bentonite clay, silica, silicate, silicon dioxide, or the like. In some embodiments, the mineral is provided in granular form.

In some embodiments, the substrate is a carrier such as a wax, such as an animal wax (e.g. beeswax), a plant wax (e.g. carnuba wax), or a petroleum-based wax (e.g. paraffin wax).

In some embodiments, the substrate is porous. In some embodiments, the pores have an average diameter of from about 5 to about 500 micrometers, or any amount or range there between, for example from about 10 to about 200, or from about 50 to about 150 micrometers, including any value therebetween, e.g. 25, 50, 100, 150, 200, 250, 300, 350, 400 or 450 micrometers.

In some embodiments, the substrate is a porous plastic. In some embodiments, the porous plastic comprises polyethylene, polyethylene terephthalate or polyester fibres. The fibres may be felted or glued, or fused to provide an open cell or porous structure that is non-woven.

The substrate should be selected to be compatible with the pesticidal or pest control active solution to be released, and should be mechanically strong to retain a porous structure and be resistant to degradation such by an active ingredient, solvent, carrier or emulsifier and/or adjuvant compound. Without being bound by theory, it is believed that any material that provides appropriate gaps between the fibers for receiving and absorbing a pesticidal or pest control active composition can be used in some embodiments of the present invention, regardless of whether the material is woven or non-woven. The gaps are believed to provide a space for receiving (i.e. absorbing) the liquid pesticidal or pest control active composition, and the fibers are believed to assist with transporting the liquid pesticidal or pest control active composition throughout the substrate to facilitate release of pesticidal or pest control active vapors.

In some embodiments, the pesticide-impregnated substrate is replaced with a gelled pesticidal or pest control active composition, i.e. a pesticidal or pest control active composition which has been provided with a solid or semi-solid gel consistency by the addition of appropriate gelling agents.

In some embodiments, the pesticidal or pest control active composition is formulated into a solid or gel that serves as a vehicle for releasing pesticidal or pest control active vapors. For example, alginate, agar or any other gelling or thickening agent may be used to gel an aqueous solution containing a pesticidal or pest control active composition, including for example suitable polymers. The gel may comprise natural gelling agents, or synthetic gelling agents, or a combination thereof. Examples of natural gelling agents include starches, agars, gums, pectin, proteins, collagen, gelatin, furcellaran, saccharides, hydrocolloids, and the like. Examples of synthetic gelling agents include silicones, polyethylene glycol (PEG), polyvinyl alcohol, or the like.

Addition of a gelling agent to an aqueous solution forms a weakly cohesive internal structure, to form a homogeneous gel (which may be solid or semi-solid, or creamy or pasty in some embodiments) from a solution of a pesticidal or pest control active composition. Pesticidal or pest control active vapors are then released from the gel.

In some embodiments, the pesticidal or pest control active composition is absorbed or impregnated into a porous solid substrate or provided as a gel. In some embodiments, the solid substrate or gel compositions assist with controlling the rate of release of pesticidal or pest control active vapors. While the embodiments described below are described with reference to the use of a substrate impregnated with a pesticidal or pest control active composition or a liquid pesticidal or pest control active composition contained in some suitable manner, in some embodiments, the substrate or the liquid composition are replaced with a pesticidal or pest control active composition in gel form.

In some embodiments, the substrate is adapted to provide a visual indication of the relative amount of pesticidal or pest control active composition remaining within the substrate. In some embodiments, the substrate changes dimensions (for example, by swelling or enlarging), when the pesticidal or pest control active composition is applied to the substrate. In some embodiments, the substrate changes dimensions (for example, by shrinking), as the pesticidal or pest control active composition is released as a vapor from the substrate (for example, by evaporation). Thus, a visual inspection of the relative dimensions of the substrate can provide a visual indication of the relative amount of pesticidal or pest control active composition remaining within the substrate.

In some embodiments, the release of pesticidal or pest control active vapors from a substrate proceeds by passive means, such as diffusion, evaporation, vaporization, aerosolization, or other natural process.

In some embodiments, the release of pesticidal or pest control active vapors from a substrate proceeds by active means, i.e. the natural release of pesticidal or pest control active vapors from the substrate is enhanced by another mechanism, for example, heating, air exchange (for example by the operation of a fan), sonication, addition of a chemical compound or enzyme that stimulates release of pesticidal or pest control active vapors from the substrate or produces an exothermic reaction, addition of a gas such as CO2, application of electrical current, or the like.

In some embodiments, an effective concentration of pesticidal or pest control active vapors are used to control a pest. In some embodiments, pesticidal or pest control active vapors are contained within a treatment enclosure to enhance the efficacy of treatment of a particular pest infested article (e.g. as compared with allowing the free diffusion of pesticidal or pest control active vapors into the external environment). In some embodiments, the treatment enclosure is sealable, such that pesticidal or pest control active vapors are released and contained within a confined space. In some embodiments, the treatment enclosure is permeable to pesticidal or pest control active vapors, so that pesticidal or pest control active vapors can diffuse out of the treatment enclosure. In some such embodiments, the permeable treatment enclosure slows the rate of diffusion of pesticidal or pest control active vapors out of the treatment enclosure, as compared with the rate of diffusion of pesticidal or pest control active vapors in open air. In some such embodiments, the permeable treatment enclosure helps to retain a sufficiently high vapor concentration within the treatment enclosure for a sufficiently long period of time to control any pests within the treatment enclosure.

In some embodiments, the pesticidal or pest control active vapors are released from a liquid solution containing a pesticidal or pest control active composition that is appropriately contained, for example by being contained within a membrane that is permeable to pesticidal or pest control active vapors but not to liquid, or by being contained within a reservoir of a device for releasing pesticidal or pest control active vapors, for example as described with reference to example embodiments of such devices below. In some embodiments, a viscosity-modifying agent is added to the liquid, to modulate the rate of release of pesticidal or pest control active vapors from the liquid and/or to modulate the rate of flow of the liquid by modifying its viscosity

Some embodiments of the present invention provide methods for killing or controlling a pest comprising placing a pesticidal or pest control active composition, substrate or device as described above in the vicinity of a target pest, such that the pest is exposed to the vapors released from the composition, substrate, or device.

In some embodiments, methods comprise placing the pesticidal composition, substrate or device in an enclosed volume of space (i.e. a treatment enclosure) such that released pesticidal or pest control active vapors accumulate within the enclosed space and effectively kill or control any target pest within the space over a period of time. In some embodiments, the enclosed space is a sealable container containing objects that are infested or potentially infested by a target pest. In some embodiments, the enclosed space is a container that can be partially enclosed containing objects that are infested or potentially infested by a target pest. In some embodiments, the enclosed space is a container that is only partially permeable to pesticide vapors, and the container contains objects that are infested or potentially infested by a target pest. Examples of enclosed spaces or sealable containers that can provide a treatment enclosure in some embodiments include bags, garbage bags, garbage or recycling bins, boxes, suitcases, back packs, duffel bags, clothes bags, cabinets, totes, barrels, pet kennels and crates, shipping containers (including intermodal, standard, high-cube, hard top, ventilated, refrigerated, insulated and tank containers and the like), vehicles such as cars, trucks, buses, boats, train cars, recreational vehicles, motorhomes, cube vans, transport trucks, boats and the like, including public transportation vehicles, closets, rooms, hotel rooms, offices, dormitories, storage lockers, warehouses, greenhouses, public auditoriums (for example, theaters, concert halls, lecture halls and the like), refrigerators/freezers, bee hives, food storage containers, pre-sealed packages containing food or non-food items, retail food bags, food storage structures (e.g. silos and the like, including fruit storage containers), library shelves enclosed in sheets of plastic, book bins, and the like.

In some embodiments, the sealable containers are made of a material that is impermeable to vapors. In some embodiments, the enclosed space or sealable containers are sealed by wrapping or affixing an impermeable membrane around the space or over any areas through which vapors may leak out. In some embodiments, this impermeable membrane is stretchable plastic wrap or tape. In some embodiments, the enclosed space or sealable container is further placed within a sealed room or chamber. In some embodiments, the period of time the container is sealed or left in its enclosed state is at least 15 minutes, at least 30 minutes, at least 1 hour, at least 2 hours, at least 4 hours, at least 6 hours, at least 8 hours, at least 12 hours, at least 16 hours, or 1, 2, 3, 4, 5, 6, or 7 days, or more.

In some embodiments, a treatment enclosure is provided on a live animal, for example a mammal such as a companion animal, livestock or a human, by providing an impermeable membrane such as plastic around at least a portion of the animal. For example, external parasites such as fleas, lice, ticks, bog-flies, mites or the like, can be treated on an animal by providing a bag around the animal from which its head protrudes. The bag can be sealed around the infested portion of the animal, and pesticidal or pest control active vapors released within the bag to control pests located directly on the animal. In some embodiments, an impermeable cap, similar to a shower cap, is provided that can be placed on the head of a human as a treatment enclosure to contain pesticidal or pest control active vapors to control a pest located in the hair or scalp of the human, for example lice or ticks. In some embodiments, the animal is a dog, cat, mouse, hamster, guinea pig, bird, horse, cow, sheep, goat, pig, duck, turkey, chicken or the like.

In some embodiments, a treatment enclosure is provided on one or more live plants. For example, a plant (e.g. a potted house plant) or a group of plants (e.g. a row of plants) is covered by a bag or other impermeable membrane, and pesticidal or pest control active vapors are released inside the impermeable membrane to control pests associated with the plant. Examples of pests that can be controlled in this manner include all life stages of aphids, ants, spider mites and other mites, thrips, beetles, moths, scales, mealybugs, and other arthropods that may infest plants. In some embodiments, the amount of pesticidal or pest control active vapor released within the treatment enclosure is selected to differentially control an undesirable pest, while not harming one or more other beneficial arthropod species, for example ladybugs (which are predators of pests such as aphids) or bees or other pollinators.

In some embodiments, a method is provided for treating objects that are infested or potentially infested by pests comprising placing the infested objects in a container, placing a pesticidal or pest control active composition, substrate or device as described above into the container, and sealing the container for a sufficient time to allow the vapors of the pesticidal or pest control active composition to kill or otherwise control the pests and/or its eggs.

With reference to FIG. 13, an example embodiment of a treatment enclosure 80 in which a pesticidal or pest control active composition 46 is used to treat a target pest 82 is schematically illustrated. The target pest 82, and/or an article infested with a target pest 82, and a pesticidal or pest control active composition 46 that releases pesticidal or pest control active vapors are placed together within a treatment enclosure 80. The source of pesticidal or pest control active vapors from pesticidal or pest control active composition 46 is left in treatment enclosure 80 for a sufficient period of time to control the target pest 82.

In some embodiments, a device for releasing pesticidal or pest control active vapors, a pesticide-impregnated substrate, or a gelled pesticidal or pest control active composition is provided as an integral part of a treatment enclosure into which infested articles can be inserted for treatment.

### Impregnated Substrate

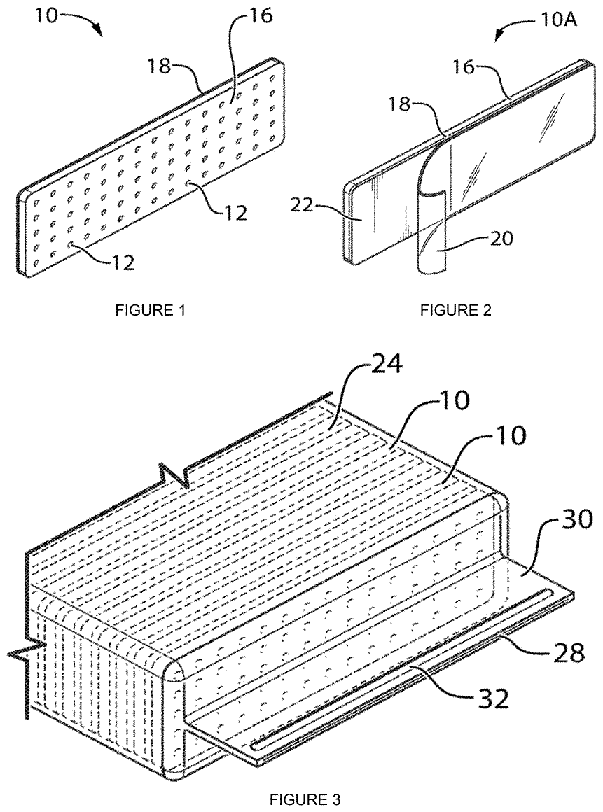

Referring now to the drawings, FIG. 1 illustrates an exemplary pesticidal or pest control device 10 for releasing pesticidal or pest control active vapors, according to an embodiment of the present disclosure. Pesticidal or pest control device 10 has an absorbent substrate 16 that has been impregnated with a pesticidal or pest control active composition or material that produces a pesticidal or pest control active vapor. Pesticidal or pest control device 10 has an impermeable membrane 18 provided on one edge of the impregnated substrate 16. In embodiments where it is provided, impermeable membrane 18 may act as a backing to help prevent the pesticidal or pest control active composition contained within impregnated substrate 16 from contacting surfaces on which pesticidal or pest control active or pest control device 10 is placed.

In the exemplary embodiment illustrated in FIG. 1, impregnated substrate 16 has a plurality of dimples 12. Dimples 12 create a waffled surface. In some embodiments, dimples 12 may serve as wells to retain an applied (or pre-dosed) pesticidal or pest control active composition to aid in absorption of that pesticidal or pest control active composition into impregnated substrate 16. For example, dimples 12 may serve to prevent an applied liquid pesticidal or pest control active composition from running off substrate 16 while the pesticidal or pest control active composition is absorbed into substrate 16. In some embodiments, dimples 12 may be formed as a result of the process of manufacturing substrate 16 and/or device 10, and may be a pressure point binding multiple layers of substrate 16. In some embodiments, dimples 12 may be formed as a result of using a peg, optionally of the same material as substrate 16, to bind multiple layers of substrate 16 together. In some additional embodiments, ridges, waves, depressions, or other surface shapes or forms may be formed in the surface of the impregnated substrate 16, or in an alternative embodiment, the surface of the impregnated substrate 16 may be substantially planar without formation of shapes in the surface thereof.

In some embodiments, an absorbent multi-layered substrate 16 may comprise fibrous material that has been ‘felted’ together with pressure and/or friction in specific locations to produce dimples 12. In some embodiments, spot applications of adhesive may be applied, such as to penetrate multiple of layers to anchor them together, while leaving the majority of the surface and layers available for absorption of the applied pesticidal or pest control active composition. In some exemplary embodiments, mechanical aids such as dowels, pins or other penetrating fasteners could be inserted through multiple layers of substrate 16, to help bind the separate layers together. In other embodiments, multiple layers of substrate 16 can be held together in any suitable manner.

In some embodiments, a base of the impregnated substrate may be substantially covered by an impermeable membrane 18 such as to prevent the release of moisture or vapors through that side so as to protect or otherwise isolate a surface on which the substrate is placed or adhered. With reference to FIG. 2, illustrating an alternative device 10A, in some embodiments, the base 18 of the substrate may comprise an adhesive strip 22 for securing the substrate, for example within a treatment enclosure. In some embodiments, a side of the substrate comprises a removable cover strip 20 covering adhesive strip 22, to protect adhesive strip 22 and help it retain its adhesive properties until device 10 is deployed and the removable cover strip 20 removed by a user. In some embodiments, both an impermeable membrane 18 and an adhesive strip 22 are provided with the impermeable membrane 18 interposing adhesive strip 22 and impregnated substrate 16.

In some embodiments, a side of the substrate 16 may comprise a removable adhesive cover strip that is impermeable to prevent the release of moisture or vapors from the substrate until after the removable adhesive coverstrip is removed (e.g. after a user has removed the removable adhesive strip to activate the device). In some embodiments, the side of the substrate comprising the removable adhesive cover strip is the side opposite to the side of the substrate on which the impermeable membrane 18 is provided.

With reference to FIG. 3, in some embodiments, one or more impregnated substrates 16 or devices 10 may be contained within an impermeable sealable package to prevent the release and escape of vapors when not in use. In the illustrated embodiment, an exemplary impermeable sealed package has a body 24 and an end 28 with a resealable opening 30. In alternative embodiments, the sealed package may just have a body with a resealable opening, with no distinct or clearly definable end like end 28 defined thereon. The resalable opening 30 can have any suitable resealable closure, for example a releasable port, a zipper-like seal, a pressure seal, a reusable adhesive seal, or the like). In the illustrated embodiment, resealable opening 30 has a resealable pressure seal 32 such as that commonly found in small plastic bags sold generally to consumers.

In some embodiments, each substrate is pre-dosed with an appropriate quantity of pesticidal or pest control active composition for easy application within a given treatment volume. In some embodiments, the substrates 16 may be pre-dosed with between 1 mL and 100 mL of pesticidal or pest control active composition. In some such embodiments, the substrates 16 are intended for use in a treatment enclosure having a volume in the range of 10 L to 1000 L, including any volume therebetween e.g. 100, 200, 300, 400, 500, 600, 700, 800 or 900 L. In some embodiments, a plurality of pre-dosed substrates 16 are packaged together in a suitable resealable package, and can be removed individually from a package when needed.

In some embodiments, a pesticidal or pest control active composition in liquid form is contained in a vessel or reservoir from which vapors are releasable. In some embodiments, vapors are released passively by a wick, diffuser or through a permeable membrane. In some embodiments, diffusion and/or evaporation may be actively aided by a heater, fan, aerator, pump, or other electrical or mechanical means. In some embodiments, evaporation is actively increased or controlled by lowering or modifying the surface tension of the pesticidal or pest control active composition via electrical or mechanical means. In some embodiments, evaporation is actively increased by adding a chemical agent to the pesticidal or pest control active composition. In some such embodiments, the chemical agent catalyzes release of vapors of the pesticidal or pest control active composition from the device. In some embodiments, the chemical agent causes an exothermic reaction that enhances release of vapors of the pesticidal or pest control active composition from the device.

Some embodiments comprise a means for actively diffusing a pesticidal or pest control active vapor, such as a fan, pump, or other such mechanical diffuser, an ultrasonic or humidifying diffuser, an evaporative diffuser, a heat diffuser, or other such diffusion-aiding components. Some embodiments comprise a means for increasing or controlling the rate of evaporation of vapors, such as a heater, fan, aerator (e.g. a device for passing air or gas through or over a solution containing a pesticidal or pest control active composition), aerosolizer (e.g. an atomizer or other device for creating a mist of a pesticidal or pest control active composition), pump, etc. Some devices comprise mechanical and/or electrical components to achieve the functions described herein.

Devices according to some embodiments of the present invention comprise a portable housing containing a pesticidal or pest control active composition, gel or substrate as described above. In some embodiments, this housing comprises mesh, slits or holes or other openings (i.e. apertures) through which vapors may be released. In some embodiments, these openings may be opened and closed by appropriate means. In some embodiments, these openings are adjustable to control the rate of release of vapors. In some embodiments, the housing comprises a permeable membrane or porous material that allows vapors to be released while containing any liquid or solid contents of the device. In some embodiments, the permeable membrane or porous material allows for the controlled release of vapors at a desired rate or dose. In some embodiments, the pesticidal or pest control active composition within the device is refillable.

### Pillow-Packaged Substrate Treatment Pad

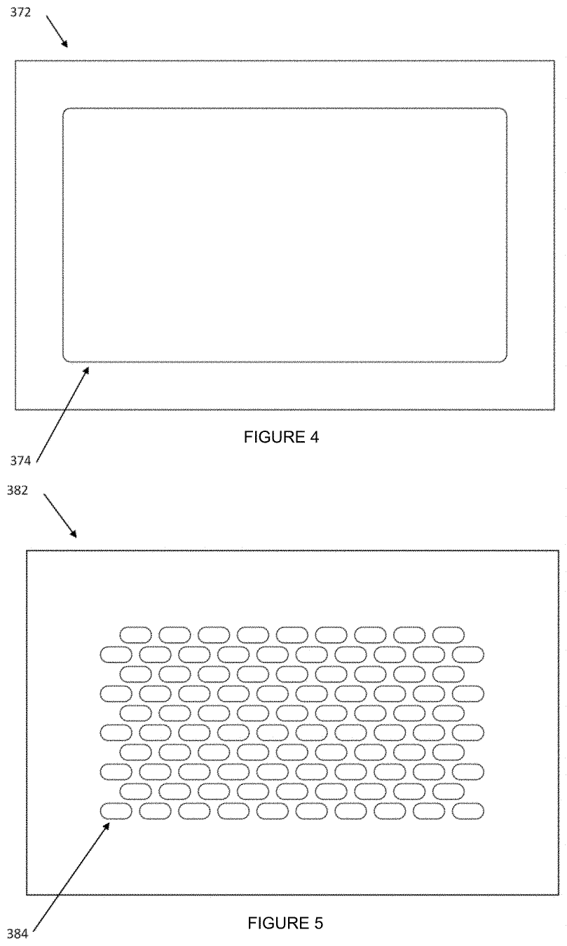

FIG. 4 shows a top view of a related exemplary pillow-packaged substrate treatment pad device 372, showing a protective peel-off strip 374 sealing over one or more vapor release apertures (not shown), and enclosing a substrate (not shown) adapted for absorption of a pesticidal or pest control active formulation, according to an embodiment of the present disclosure. In one such embodiment, the pillow-package housing of the device 372 may comprise one or more suitable impermeable materials that can be used to form a substantially vapor-impermeable outer housing of device 372, and in some embodiments may comprise any suitable plastic or similar substantially impermeable material, including but not limited to polyesters like polyethylene, low/medium and high density polyethylene, biaxially-oriented polyethylene terephthalate (e.g. Mylar™), polypropylene, biaxially oriented polypropylene, metalized polyester, nylon, biaxially oriented nylon, paper poly foil poly, ethylene-vinyl acetate, film foil laminations, poly extrusion laminations, and the like. In some embodiments, peel strip 374 may comprise any suitable substantially impermeable material adapted for sealing over one or more vapor release apertures, such as a suitable flexible film or sheet material which may be adhesively or otherwise suitable sealed to the outer housing of device 372, or alternatively may be integral with or form part of the outer housing of device 372 and be adapted for peeling away from the remainder of the outer housing, such as by release of a peelable releasable adhesive, or by separation (such as but not limited to separation of one of a plurality of layers of material) from the outer housing of device 372 such as to reveal at least a portion of the vapor release aperture(s) for facilitating release of vapors of the pesticidal or pest control active formulation, for example.

FIG. 5 shows a top view of an exemplary pillow-packaged substrate treatment pad device 382 after opening by removing a protective peel-off strip, showing an exemplary pattern of vapor release apertures 384, and enclosing a substrate (not shown) adapted for absorption of a pesticidal or pest control active formulation for release of pesticidal or pest control active vapors through the apertures, according to an embodiment of the present disclosure.

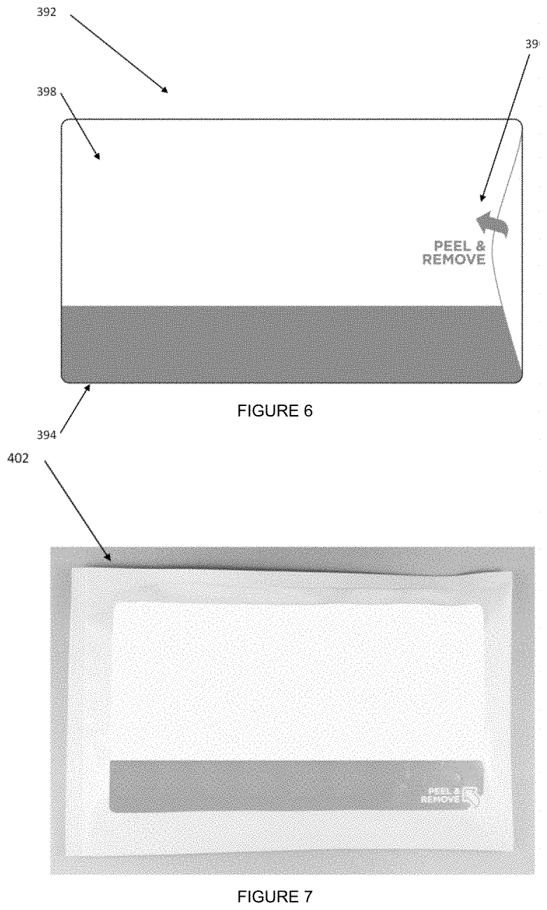

FIG. 6 shows a top view of an alternative pillow-packaged substrate treatment pad device 390, showing exemplary visual elements 394 and an exemplary instructive indicia 396 for opening of a protective peel-off strip 398 sealing over one or more vapor release apertures (not shown), for enclosing a substrate (not shown) adapted for absorption of a pesticidal or pest control active formulation, according to an embodiment of the present disclosure.

FIG. 7 shows a top view of a further exemplary pillow-packaged substrate treatment pad device 402, showing exemplary visual elements and an exemplary instructive indicia for opening of a top protective peel-off strip sealing over one or more vapor release apertures (not shown), and enclosing a substrate (not visible under strip) adapted for absorption of a pesticidal or pest control active formulation, according to an embodiment of the present disclosure.

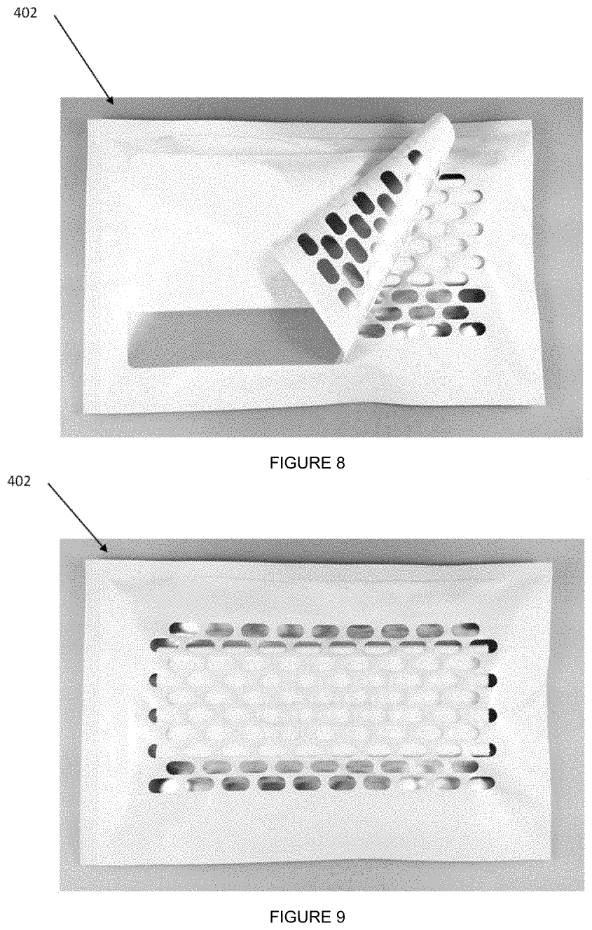

FIG. 8 shows a top view of the exemplary pillow-packaged substrate treatment pad device 402 shown in FIG. 7, showing the top protective peel-off strip partially removed to show an exemplary pattern of one or more vapor release apertures, and enclosing an exemplary substrate adapted for absorption of a pesticidal or pest control active formulation and for release of pesticidal or pest control active vapors through the apertures, according to an embodiment of the present disclosure.

FIG. 9 shows a top view of the exemplary pillow-packaged substrate treatment pad device 402, after opening by removing a peel-off strip, showing an exemplary pattern of vapor release apertures, and enclosing an exemplary substrate adapted for absorption of a pesticidal or pest control active formulation for release of pesticidal or pest control active vapors through the apertures, according to an embodiment of the present disclosure.

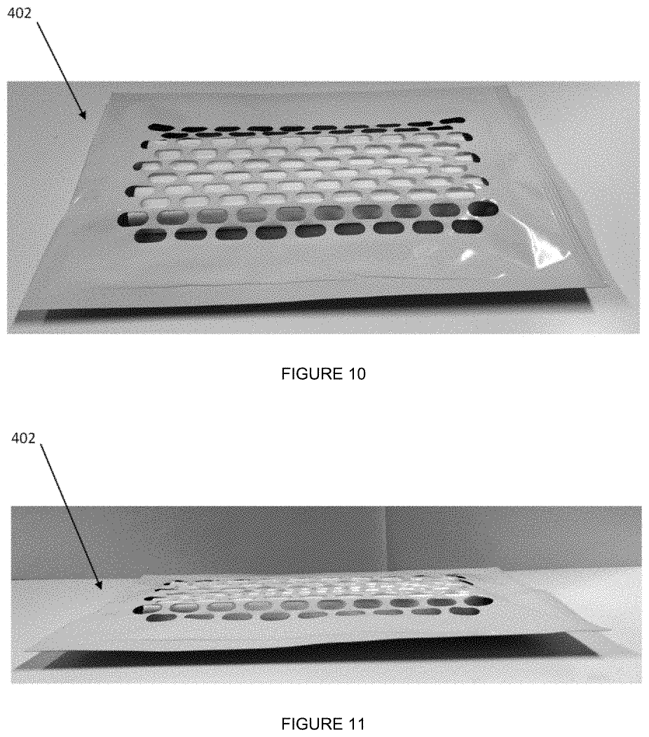

FIG. 10 shows a perspective view of the pillow-packaged substrate treatment pad device 402, showing the side and top of the pad after opening by removing a peel-off strip, showing an exemplary pattern of vapor release apertures, and enclosing an exemplary substrate adapted for absorption of a pesticidal or pest control active formulation for release of pesticidal or pest control active vapors through the apertures, according to an embodiment of the present disclosure.

FIG. 11 shows a side or edge view of the pillow-packaged substrate treatment pad device 402 showing the side or edge of the pad after opening by removing a peel-off strip, showing an exemplary pattern of vapor release apertures, and enclosing an exemplary substrate adapted for absorption of a pesticidal or pest control active formulation for release of pesticidal or pest control active vapors through the apertures, according to an embodiment of the present disclosure.

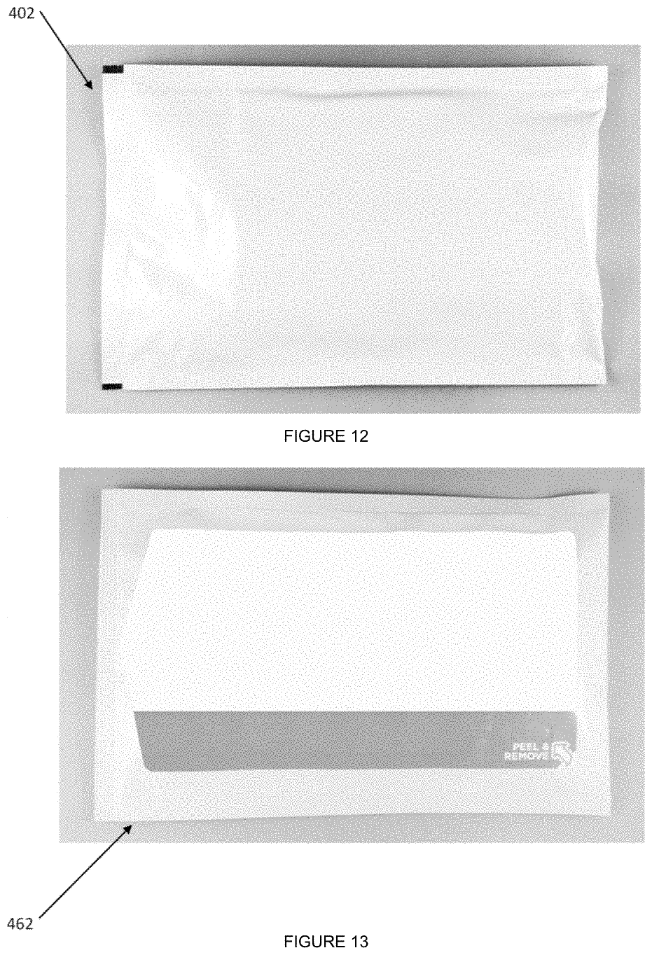

FIG. 12 shows a bottom view of a pillow-packaged substrate treatment pad device 402, adapted for enclosing a substrate (not shown) adapted for absorption of a pesticidal or pest control active formulation, according to an embodiment of the present disclosure.

FIG. 13 shows a top view of an exemplary alternative pillow-packaged substrate treatment pad device 462, showing visual elements and an instructive indicia for opening of a top protective peel-off strip sealing over one or more vapor release apertures (not visible under strip), and enclosing a substrate (not shown) adapted for absorption of a pesticidal or pest control active formulation, according to an embodiment of the present disclosure.

Examples of objects that may be treated according to embodiments of the present invention include books, art-work, toys, clothing, linens, footwear, documents, DVDs, electronics, computers, phones, furniture, luggage, bedding, pallets, crates, lumber, firewood, soil, plants, pets, items being shipped in a shipping container, bee hives, food, food storage containers, or any other object that may be infested with a target pest. In some embodiments, such infested objects are referred to as infested articles.

### Treatment Enclosure

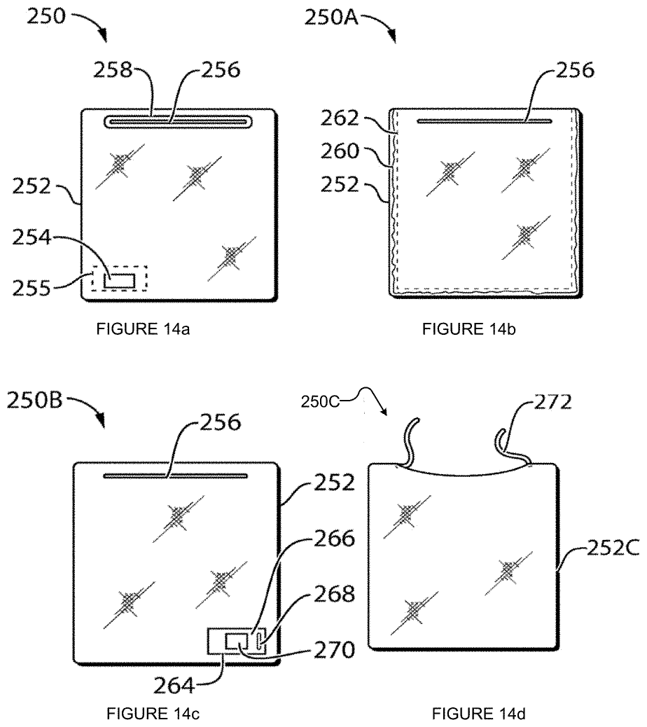

With reference to FIG. 14a, an exemplary treatment enclosure 250 is illustrated, according to an embodiment of the present disclosure. Treatment enclosure 250 has an impermeable or substantially impermeable outer layer 252. In some embodiments, impermeable outer layer 252 is a plastic bag. At least one substrate, gel or device 254 for releasing an effective amount of a pesticidal or pest control active vapor is adhered to or otherwise provided within outer layer 252. In some embodiments, the substrate, gel or device 254 is covered by a protective mesh or wire housing 255, to prevent direct contact between infested articles inserted in outer layer 252 and vapor release device 254. In some embodiments, protective mesh or wire housing 255 is directly secured on the inside surface of outer layer 252. In some embodiments, a plurality of substrates, gels and/or devices 254 are provided within outer layer 252.

In the embodiment illustrated in FIG. 14a, outer housing 252 is provided with a resealable opening 256. In use, a user can open resealable opening 256, insert infested articles inside outer housing 252, re-seal resealable opening 256, leave opening 256 sealed for a predetermined treatment period (e.g. 1 hour, 1 day, one week, or any time interval therebetween) to control pests associated with the infested articles, and then open resalable opening 256 to remove the treated articles.

In some embodiments, including the embodiment illustrated in FIG. 14a, outer housing 252 is provided with a tear strip 258 or other suitable member that sealingly covers opening 256, to prevent the inadvertent release of pesticidal or pest control active vapors from treatment enclosure 250 before a user is ready to insert infested articles. For example, tear strip 258 could be a partially perforated section of plastic or the like, which is initially sealed, but which can be easily torn off by a user to access opening 256 when it is intended to use treatment enclosure 250 (e.g. similar to tear away plastic coverings over resealable openings on commercially sold food items).

In the embodiment illustrated in FIG. 14b, an exemplary multi-layered treatment enclosure 250A is illustrated, according to an embodiment. Treatment enclosure 250A has an impermeable or generally impermeable outer housing 252, and an inner substrate lining 260 that is a substrate impregnated with a pesticidal or pest control active composition. Inner substrate lining 260 sits inside outer housing 252 and lines the inside surface of treatment enclosure 250, to release pesticidal or pest control active vapors to treat infested articles placed therein. Inner substrate lining 260 is pre-dosed with an effective amount of a pesticidal or pest control active composition to provide an effective vapor concentration to control pests associated with infested articles inserted in treatment enclosure 250A. As in the embodiment illustrated in FIG. 14b, in some embodiments, a permeable inner membrane 262 is provided on the inside surface of inner substrate lining 260, to prevent infested articles from coming in direct contact with inner substrate lining 260 while allowing pesticidal or pest control active vapors to permeate throughout the volume of the treatment enclosure 250A. In some embodiments, permeable inner membrane 262 is omitted. Treatment enclosure 250A is provided with a resealable opening 256, so that a user can insert and seal infested articles within treatment enclosure 250A for a treatment period.

With reference to FIG. 14c, an exemplary reusable treatment enclosure 250B is illustrated, according to an embodiment of the present disclosure. Treatment enclosure 250B has an outer impermeable layer 252 and a resealable opening 256, to allow a user to insert and remove infested articles from treatment enclosure 250B after a suitable treatment period. Treatment enclosure 250B further has at least one side pocket 264, and may have a plurality of side pockets 264. The outer surface of side pocket 264 is continuous with outer impermeable layer 252, or is sealingly engaged therewith. The inner surface of side pocket 264 comprises a permeable membrane 266. A source of pesticidal or pest control active vapors 270, which can be a device for releasing pesticidal or pest control active vapors, a substrate impregnated with a pesticidal or pest control active composition, or a gel of a pesticidal or pest control active composition, can be placed within pocket 264 via a resealable opening 268. Vapors released from the source of pesticidal or pest control active vapors 270 can diffuse into the interior of treatment enclosure 250B via permeable membrane 266. In use, a user inserts infested articles into enclosure 250B via resealable opening 256, and inserts a source of pesticidal or pest control active vapors into side pocket 264 via resealable opening 268. Both openings 256 and 268 are sealed, and the infested articles are left within the sealed treatment enclosure 250B for a predetermined treatment period to control pests on the infested articles. The articles can then be removed from treatment enclosure 250B, and the spent source of pesticidal or pest control active vapors 270 can be removed from side pocket 264 and disposed of in a suitable manner Treatment enclosure 250B is then ready for subsequent re-use to control pests on infested articles by repeating the above steps.

In some embodiments, outer layer 252 of treatment enclosure 250B is a pliable impermeable membrane, such as a plastic bag. In some embodiments, outer layer 252 of treatment enclosure 250B is a more durable material, for example rigid plastic or rubber, metal, wood, cardboard, expanded polystyrene, glass or the like to facilitate long term re-use of treatment enclosure 250B. In some embodiments, professional pest control personnel may maintain a stock of reusable treatment enclosures similar to treatment enclosure 250B, to facilitate repeated treatment of infested articles.

With reference to FIG. 14d, an exemplary single-layer treatment enclosure 250C is illustrated according to an embodiment of the present disclosure. Treatment enclosure 250C comprises a single layer 252C that is impermeable or generally impermeable to pesticidal or pest control active vapors. Single layer 252C is also impregnated with a pesticidal or pest control active composition, so that when infested articles are placed within treatment enclosure 250C, the infested articles will be exposed to an effective amount of pesticidal or pest control active vapor to control pests on the infested articles. Treatment enclosure 250C can be closed in any suitable manner, for example using a resealable opening such as resealable opening 256. In the illustrated embodiment, treatment enclosure 250C can be closed via a drawstring 272, to enclose infested articles within treatment enclosure 250C. While pesticidal or pest control active vapors will be released both inside and outside of treatment enclosure 250C, the concentration of pesticide impregnated within single layer 252C is sufficient to provide effective control of pests enclosed inside treatment enclosure 250C. Some embodiments such as treatment enclosure 250C may be particularly advantageous in outdoor applications, for example in the treatment of a plant infested with aphids or other pests, where there is limited concern for any odor released by the pesticidal or pest control active treatment.

In some embodiments, the effectiveness of the pesticidal or pest control active vapor in controlling a target pest may be enhanced by the release of a stimulation agent before, after, or at the same time as the release of the pesticidal or pest control active vapors. The stimulation agent may act as stimulant or attractant to the target pest, such that the pest moves about more, moves closer to the release of pesticidal or pest control active vapors and/or moves out of safe harborages into open space. The stimulation agent may act to increase the metabolic rate and/or the breathing rate of the target pest, such that its bio-uptake of pesticidal or pest control active vapors is increased. The stimulation agent may otherwise serve to stimulate the target pest to be more active than it would be without the presence of the stimulation agent, thereby increasing the likelihood it will be exposed to and affected by the pesticidal or pest control active vapors.

In some embodiments, the stimulation agent may comprise carbon dioxide (CO2), nitrogen (N2), a propellant, or an inert gas. In other embodiments, the stimulation agent may comprise a pheromone, kairomone, allomone, repellent, or other semiochemical, or a phagostimulant. In other embodiments, the stimulation agent is heat. In other embodiments, the stimulation agent is moisture or water vapor. In other embodiments, the stimulation agent is light, darkness, vibration or air movement. In other embodiments, the stimulation agent is color. In other embodiments, the stimulation agent is ultrasound.

In some embodiments, the volume within the treatment enclosure (which is a sealed container in some embodiments) is in the range of 10 L to 200 L and the amount of pesticidal or pest control active composition used may be in the range of 1 mL and 200 mL. In some other embodiments, for example where the treatment enclosure has a very large volume such as a shipping container, the treatment enclosure may have a volume in the range of 300,000 to 1,000,000 L, including any value therebetween. In some embodiments, the amount of pesticidal or pest control active composition used is in the range of 1 mL to 100 mL per 100 L of volume of the treatment enclosure. In one example embodiment, a treatment enclosure having a volume in the range of 100 L to 1200 L (for example, a sufficiently large volume to accommodate a king size mattress) is provided, and between about 1 mL to 1 L of pesticidal or pest control active composition is provided on a pre-dosed substrate, or split among a plurality of pre-dosed substrates, for insertion into the treatment enclosure.

In some methods, the vapor concentration within the treatment enclosure (which is a sealed container in some embodiments), expressed as the percent of the amount of pesticidal or pest control active composition evaporated relative to the total volume of the container, is greater than 0.01%. In some methods, the vapor concentration within the sealed container, expressed as the amount of pesticidal or pest control active composition applied relative to the total volume of the container, is in the range of 0.01% to 0.2%. In some embodiments in which it is desired to control an undesirable arthropod pest while not harming a beneficial arthropod species, the vapor concentration within the sealed container, expressed as the amount of pesticidal or pest control active composition applied relative to the total volume of the container, is in the range of 0.01% to 0.15%.

### Non-Adhesive Treatment Package

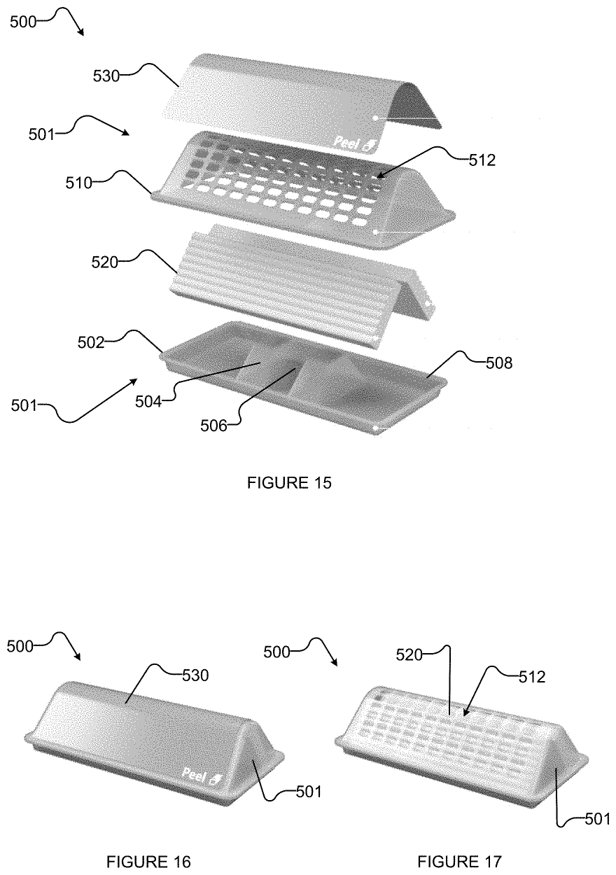

FIG. 15 shows an exploded isometric view of an exemplary rigid package 500. Package 500 comprises a housing 501 which, when assembled, contains a substrate 520 adapted for absorption of a pesticidal or pest control active formulation. Housing 501 sealably contains substrate 520, e.g. via a seal 530. In some embodiments, housing 510 comprises a first portion 502 and a second portion 510 which are bonded together to form an integral housing 501 (e.g. as shown in FIGS. 16 and 17).

At least some embodiments of package 500 provide non-adhesive sealing of the pesticidal or pest control active composition within housing 501. The inventors have observed, through experiment, that certain pesticidal or pest control active compositions can be incompatible with certain adhesive binding substances, leading to potential leakage of the pesticidal or pest control active compositions from adhesively-bonded packages. Package 500, if non-adhesively sealed at least between those elements exposed to the pesticidal or pest control active composition, may reduce or avoid such leakage in at least some circumstances. (Elements no exposed to the pesticidal or pest control active compositions, or exposed only briefly, may optionally be adhesively sealed without necessarily increasing the risk of leakage materially.)

In at least some embodiments, seal 530 is removably bonded to the housing of package 500 via a non-adhesive bond. For example, seal 530 may be heat sealed to the housing. In some embodiments, seal 530 is peelable, e.g. where seal 530 is impermanently bonded to the housing via heat sealing, such as via a peelable in-mold labelling technique. Seal 530 seals over one or more vapor release apertures 512, and together with housing 501 encloses a substrate 520 adapted for absorption of a pesticidal or pest control active formulation.

In-mold labelling is a family of techniques whereby labels (e.g. of paper, plastic, or another suitable material) are bonded to containers during the manufacture of the container by blow molding, injection molding, thermoforming processes, and/or the like. The labels are placed in the mold when the container is created, resulting in an integrally-formed, labelled product. A heat seal layer may be provided to assist the bonding of the label to the container during manufacture without necessarily requiring the use of adhesives. Heat sealing parameters may be set appropriately (depending on the material) to create a non-permanent bond that allows the label to be peeled off.

In at least some embodiments, first portion 502 and second portion 510 of housing 501 (and/or such other portions of housing 501 containing a pesticidal or pest control active composition) are non-adhesively bonded. For example, first portion 502 and second portion 510 may be formed separately (e.g. by the processes discussed elsewhere herein) and bonded via ultrasonic welding and/or any other suitable non-adhesive bonding technique. Portions 502, 510 may be sealably bonded such that, when seal 530 is in place, housing 501 together with seal 530 is substantially vapor-impermeable. Housing 501 defines a cavity for containing a pesticidal or pest control active composition impregnated substrate 520 and thus can reduce or avoid leakage of pesticidal or pest control active composition while sealed.

In some embodiments, the pesticidal or pest control active composition is heavier than air and housing 501 defines apertures 512 on surfaces which are non-coplanar. For example, housing 501 may provide apertures 512 on surfaces at opposing ends of housing 512. For example, housing 501 may provide apertures on surfaces which are at an angle relative to each other of less than 180° (note that the surfaces do not necessarily meet at such an angle; for instance, the surfaces may not meet directly, and/or may provide a rounded, chamfered, or otherwise shaped meeting, e.g. as shown in FIG. 15). This can assist with release of pesticidal or pest control active composition in vapor form in various spatial orientations of housing 501. In some embodiments, e.g. in the depicted embodiment of FIG. 15, housing 501 provides apertures on surfaces which are at an angle relative to each other of less than 90°, which can assist with avoiding inadvertent blockage of apertures 512 when package 500 is placed in common locations such as boxes or in corners. In some embodiments, housing 501 is substantially triangular in cross-section (e.g. as shown in FIG. 15).

In some embodiments, housing 501 provides one or more supports 504 for supporting substrate 520. In some embodiments, housing 501 is configured to contain first and second substrates 520 and, via supports 504, holds first and second substrates 520 apart to define an opening between first and second substrates 520 for delivery (e.g. via injection, deposition, or other suitable delivery) of a pesticidal or pest control active composition. Housing 501 may additionally, or alternatively, provide a deflection surface 506 for deflecting such composition passing through the opening toward one or more of substrates 520. In some embodiments, including the exemplary depicted embodiment, deflection surface comprises a wedge shape with a forward edge of the wedge shape oriented toward the opening (i.e. towards where the opening would be if substrates 520 were inserted to rest on supports 504).

FIG. 16 shows an isometric view of package 500 of FIG. 15 while package 500 is sealed by seal 530. FIG. 17 shows an isometric view of package 500 of FIG. 15 while package 500 is unsealed, e.g. after seal 530 has been peeled away from housing 501.

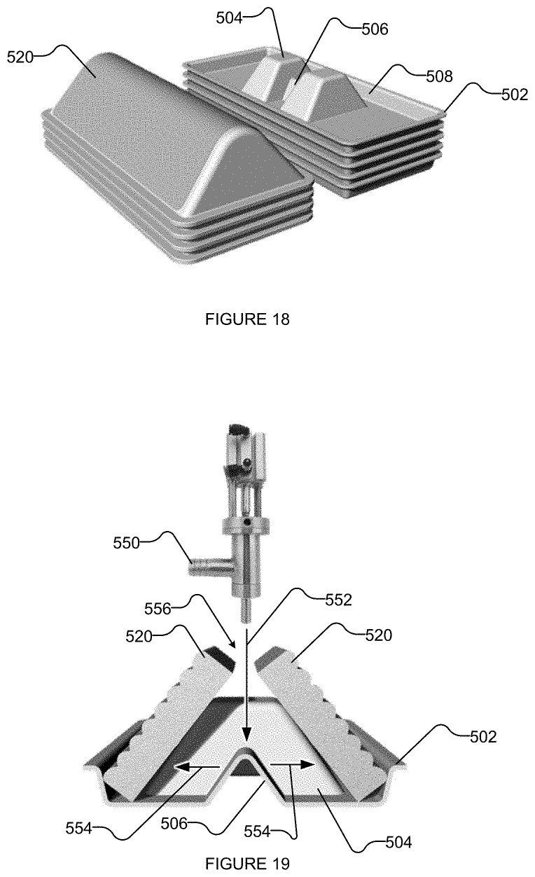

In some embodiments, portions 502 and/or 510 provide correspondingly-shaped top and bottom surfaces which are mateable, such that a plurality of portions 502 may be stacked and/or a plurality of portions 510 may be stacked. Such stacking may be advantageous, for instance, between molding and assembly. FIG. 18 shows an isometric view of a plurality of exemplary packages 500 stacked together.

Package 500 may be manufactured in any suitable way. An exemplary method of manufacture is disclosed herein. In at least some embodiments, housing 501 is manufactured by a suitable molding process, such as blow molding, injection molding, thermoforming processes, and/or the like. Housing 501 may be formed from polypropylene, polyethylene (e.g. high-density polyethylene), and/or any other suitable material. Portions 502, 510 may be formed separately and subsequently bonded. One or more portions of housing 501 (e.g. portion 510 in the example depicted embodiment) may be bonded with seal 530 by placing seal 530 in the mold before molding the portion(s) and, during and/or after molding, heat sealing seal 530 to the portion(s).

Once housing 501 (and/or portions thereof) are molded, one or more substrate(s) 520 are placed in housing 501 (e.g. by resting substrate(s) 520 on support(s) 504, as shown in FIG. 19). In some embodiments, substrate(s) 520 are dosed with a pesticidal or pest control active composition prior to insertion into housing 501. Substrate(s) 520 may be sealed within housing 501, e.g. by bonding first and second portions 502, 510 (e.g. by ultrasonic welding and/or other techniques, as disclosed above) and/or by sealing seal 530 to housing 501, as appropriate.

In some embodiments, substrate(s) 520 are dosed with a pesticidal or pest control active composition after insertion into housing 501. FIG. 19 shows cross-sectional schematic view of an example system for dosing substrate(s) 520 of package 500 with a pesticidal or pest control active composition. A dispenser 550 dispenses the pesticidal or pest control active composition substantially in direction 552 toward deflecting surface 506 (e.g. through opening 556 between substrates 520). The pesticidal or pest control active composition is deflected thereby substantially in direction(s) 554 toward substrate(s) 520, which at least partially absorb the pesticidal or pest control active composition. Prior to absorption, the pesticidal or pest control active composition is substantially and/or entirely contained within housing 501 by surfaces of portion 502 (such as surface 506, support 504, and lower portions of portion 502) and substrate(s) 520. Although the depicted embodiment provides two substrates 520, more or fewer may be provided; for example, a single substrate may be provided (e.g. with housing 501 optionally providing additional surfaces to limit and/or prevent escape of the composition during doses.) In at least some circumstances, at least the depicted embodiment limits or prevents overflow and/or splashing of the composition outside of housing 501.

In at least some embodiments, after said dosing, the method of manufacture further comprises sealing substrate(s) 520 within housing 501, e.g. by bonding first and second portions 502, 510 (e.g. by ultrasonic welding and/or other techniques, as disclosed above) and/or by sealing seal 530 to housing 501, as appropriate.

Some embodiments of the present invention can be used to control pests that are arthropods, including insects and arachnids, and/or other pests. Some embodiments of the present invention can be used to control sucking and biting pests, including bed bugs, mites, ticks, fleas, ants, lice, mosquitoes and cockroaches. Exemplary results are presented in this specification demonstrating the control of exemplary arthropod pests using vapors of a pesticidal or pest control active composition, such as bed bugs. Based on the similarity of terrestrial arthropods, including insects, with respect to organism size, cellular respiration, and other morphological respiratory structures, it can be soundly predicted that pesticidal or pest control active compositions and devices as described herein can be used to control other terrestrial arthropod pests, including subterranean arthropod pests. In other embodiments, pesticidal or pest control active compositions and devices as described herein may also be used to control other types of pests such as mites, or nematodes, for example.

Some embodiments can be used to control pests by killing the pests, repelling the pests, preventing or reducing feeding, preventing or reducing oviposition, preventing or reducing eclosion of their eggs, or the like. Some embodiments exhibit effective pesticidal or pest control active activity as a vapor. Some embodiments provide methods of killing or controlling pests comprising moistening or otherwise impregnating a substrate with the composition and placing the material in the vicinity of the pests such that they are exposed to the vapors of the composition as they are released from the substrate.

### EXAMPLES

### Example 1: Efficacy of Exemplary Volatile Pesticidal Compositions Applied in an Enclosed Treatment Enclosure

The following examples utilize three pesticidal or pest control active compositions referred to as ‘Solution A’, ‘Solution B’, and ‘Solution C’. Solution A (also referred to as “TER-1010” in Tables) contained 5.5% cold pressed neem oil by weight, 5% acetophenone by weight, 50% methyl acetate by weight as a vapor forming carrier, and 39.5% benzyl alcohol by weight as a diluent. Solution B (also referred to as “TER-1011”) contained 5.5% cold pressed neem oil by weight, 5% acetophenone by weight, and 89.5% methyl acetate by weight as a vapor forming carrier. Solution C (also referred to as “TER-909”) contained 5.5% cold pressed neem oil by weight, 1.25% ethoxylated castor oil by weight, 50% methyl acetate by weight as a vapor forming carrier, and 43.25% propylene glycol by weight as a diluent.

All experiments were conducted at room temperature (approximately 21±2° C.). Without being bound by theory, changes in temperature may affect the release of vapor from the pesticidal or pest control active composition, so lower concentrations may be effective at higher temperatures, and higher concentrations may be required at lower ambient temperatures. Based on experiments conducted by the inventors, the compositions tested in these examples maintain efficacy at temperatures of 15° C. or higher, and can reasonably be expected to remain effective at lower temperatures, although higher treatment concentrations may be required at lower temperatures.

### Example 1.1: Efficacy of Pesticidal Vapors from Pesticidal Composition Solution A Against Adult Bed Bugs on Bag-Enclosed Bed Mattress

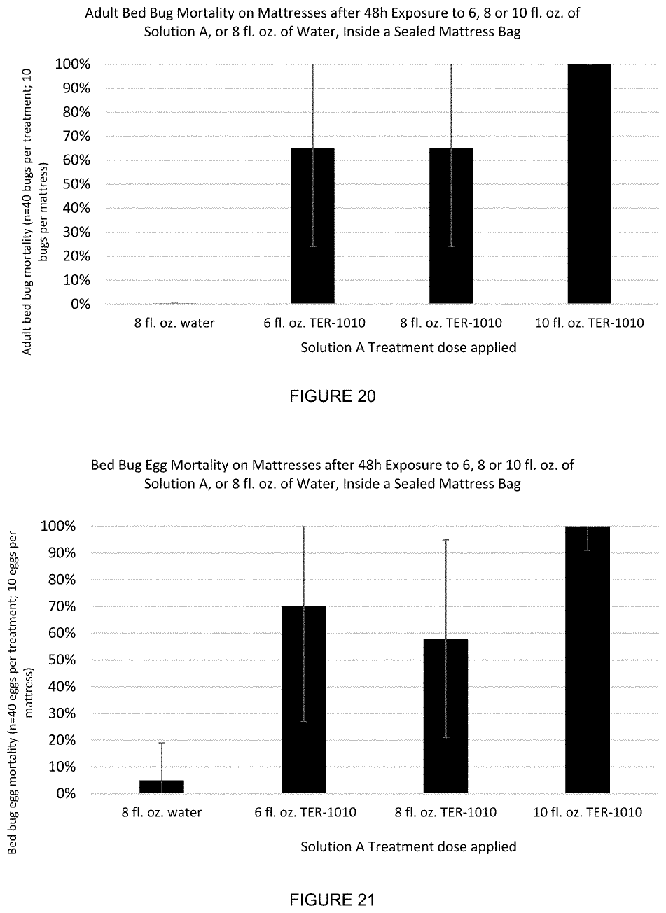

Adult bed bugs were observed for signs of toxicity, mortality and oviposition at 48 hours after bed bugs were introduced to 6, 8 and 10 fl. oz. doses of pesticidal composition Solution A inside a sealed plastic bag containing a bed mattress. As shown, in FIG. 20, at a 10 fluid oz. dose of Solution A, 100% bed bug mortality was observed at 48 hrs, indicating that pesticidal vapors emitted by Solution A can cause bed bug mortality, and that direct contact with treated surfaces are not necessary to induce mortality. A total of 4 mattresses each infested with 10 adult bed bugs were tested for each treatment group in this example. As also shown in FIG. 20, a control dose of 8 fl. oz. of water inside equivalent sealed mattress bags containing a bed mattress, was not effective to kill adult bed bugs over the tested 48 hr interval.

In a similar experimental setup to that of the example 1.1 described above, an 8 fl. oz. dose of Solution C was also found to be effective to produce 100% mortality of adult bed bugs on a king-sized bed mattress after 24 h and 48 hr exposure to the 8 oz. dose of Solution B inside a sealed mattress bag. In another similar experimental setup to that of the example 1.1 described above, a 10 fl. oz. dose of Solution B was also found to be effective to produce 100% mortality of adult bed bugs on a king-sized bed mattress after 24 and 48 hr exposure to the 10 oz. dose of Solution B inside a sealed mattress bag. In a further similar experimental setup to that of the example 1.1 described above, an 8 fl. oz. dose of a Solution D (also referred to as “TER-965”) comprising 5.5% cold pressed neem oil, 1.25% ethoxylated castor oil, 20% isopropanol, 40% acetone as a vapor forming carrier, and 33.25% propylene glycol as a diluent, was also found to be effective to produce 100% mortality of adult bed bugs on a king-sized bed mattress after 48 hr exposure to the 8 oz. dose of Solution D inside a sealed mattress bag.

In yet another similar experimental setup to that of the example 1.1 described above, an 8 fl. oz. dose of a Solution E (also referred to as “TER-952”) comprising 5.5% cold pressed neem oil, 1.25% ethoxylated castor oil, 20% isopropanol, 20% acetone as a vapor forming carrier, and 53.25% propylene glycol as a diluent, was also found to be effective to produce 100% mortality of adult bed bugs on a king-sized bed mattress after 5 day exposure to the 8 oz. dose of Solution E inside a sealed mattress bag. In another similar experimental setup to that of the example 1.1 described above, an 8 fl. oz. dose of a Solution F (also referred to as “TER-966”) comprising 5.5% cold pressed neem oil, 1.25% ethoxylated castor oil, 20% tert-butanol, 20% acetone as a vapor forming carrier, and 53.25% propylene glycol as a diluent, was also found to be effective to produce 100% mortality of adult bed bugs on a king-sized bed mattress after 5 day exposure to the 8 oz. dose of Solution F inside a sealed mattress bag. In a further similar experimental setup to that of the example 1.1 described above, an 8 fl. oz. dose of a Solution G (also referred to as “TER-963”) comprising 5.5% cold pressed neem oil, 1.25% ethoxylated castor oil, 20% methanol, 20% acetone as a vapor forming carrier, and 53.25% propylene glycol as a diluent, was also found to be effective to produce 100% mortality of adult bed bugs on a king-sized bed mattress after 5 day exposure to the 8 oz. dose of Solution G inside a sealed mattress bag.

### Example 1.2: Efficacy of Pesticidal Vapors from Pesticidal Composition Solution A Against Bed Bug Eggs on Bag-Enclosed Bed Mattress

Bed bug eggs were observed for signs of toxicity and mortality at 48 hours after bed bug eggs were introduced to 6, 8 and 10 oz doses of pesticidal composition Solution A inside a sealed plastic bag containing a bed mattress. As shown, in FIG. 21, at a 10 fluid oz. dose of Solution A, 100% bed bug egg mortality was observed at 48 hrs, indicating that pesticidal vapors emitted by Solution A can cause bed bug egg mortality, and that direct contact with treated surfaces are not necessary to induce mortality. A total of 4 mattresses each infested with 10 bed bug eggs were tested for each treatment group in this example. As also shown in FIG. 21, a control dose of 8 fl. oz. of water inside equivalent sealed mattress bags containing a bed mattress, was substantially not effective to kill bed bug eggs over the tested 48 hr interval.

### Example 1.3: Efficacy of Pesticidal Vapors from Pesticidal Composition Solution A Against Adult Dust Mites on Bag-Enclosed Bed Mattress

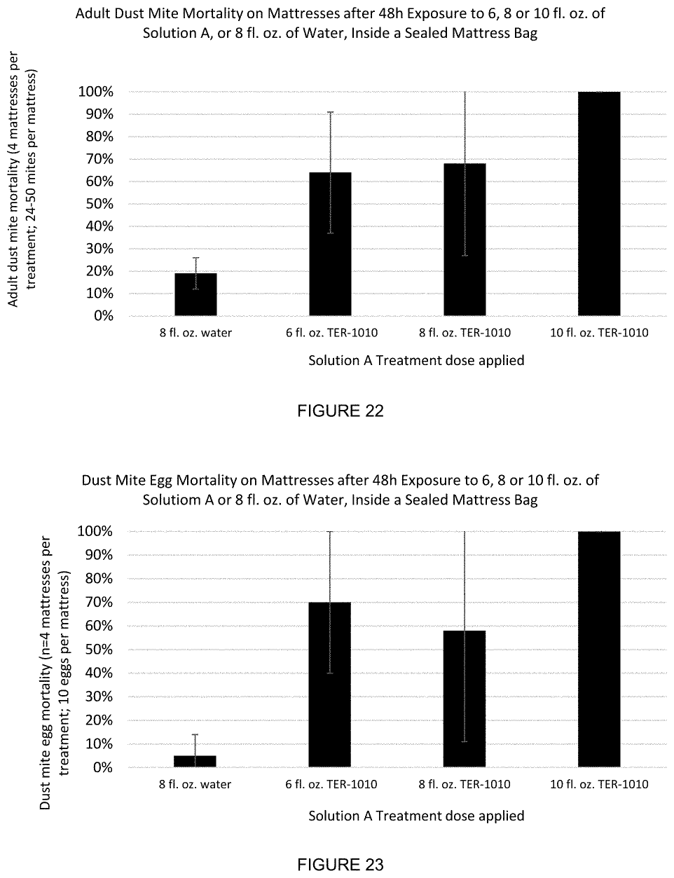

Adult dust mites were observed for signs of toxicity and mortality at 48 hours after adult dust mites were introduced to 6, 8 and 10 oz doses of pesticidal composition Solution A inside a sealed plastic bag containing a bed mattress. As shown, in FIG. 22, at a 10 fluid oz. dose of Solution A, 100% adult dust mite mortality was observed at 48 hrs, indicating that pesticidal vapors emitted by Solution A can cause adult dust mite mortality, and that direct contact with treated surfaces are not necessary to induce mortality. A total of 4 mattresses each infested with 24-50 adult dust mites were tested for each treatment group in this example. As also shown in FIG. 22, a control dose of 8 fl. oz. of water inside equivalent sealed mattress bags containing a bed mattress, was substantially not effective to kill adult dust mites over the tested 48 hr interval, and resulted in less than 20% mortality.

### Example 1.4: Efficacy of Pesticidal Vapors from Pesticidal Composition Solution A Against Dust Mite Eggs on Bag-Enclosed Bed Mattress

Dust Mite eggs were observed for signs of toxicity and mortality at 48 hours after dust mite eggs were introduced to 6, 8 and 10 oz doses of pesticidal composition Solution A inside a sealed plastic bag containing a bed mattress. As shown, in FIG. 23, at a 10 fluid oz. dose of Solution A, 100% dust mite egg mortality was observed at 48 hrs, indicating that pesticidal vapors emitted by Solution A can cause dust mite egg mortality, and that direct contact with treated surfaces are not necessary to induce mortality. A total of 4 mattresses each infested with 10 dust mite eggs were tested for each treatment group in this example. As also shown in FIG. 23, a control dose of 8 fl. oz. of water inside equivalent sealed mattress bags containing a bed mattress, was substantially not effective to kill adult dust mites over the tested 48 hr interval, and resulted in less than 5% mortality.

### Example 1.5: Efficacy of Pesticidal Vapors from Pesticidal Composition Solution A Against Adult Bed Bugs on Garbage Bag-Enclosed Clothes, Books or Non-Adsorbent Items

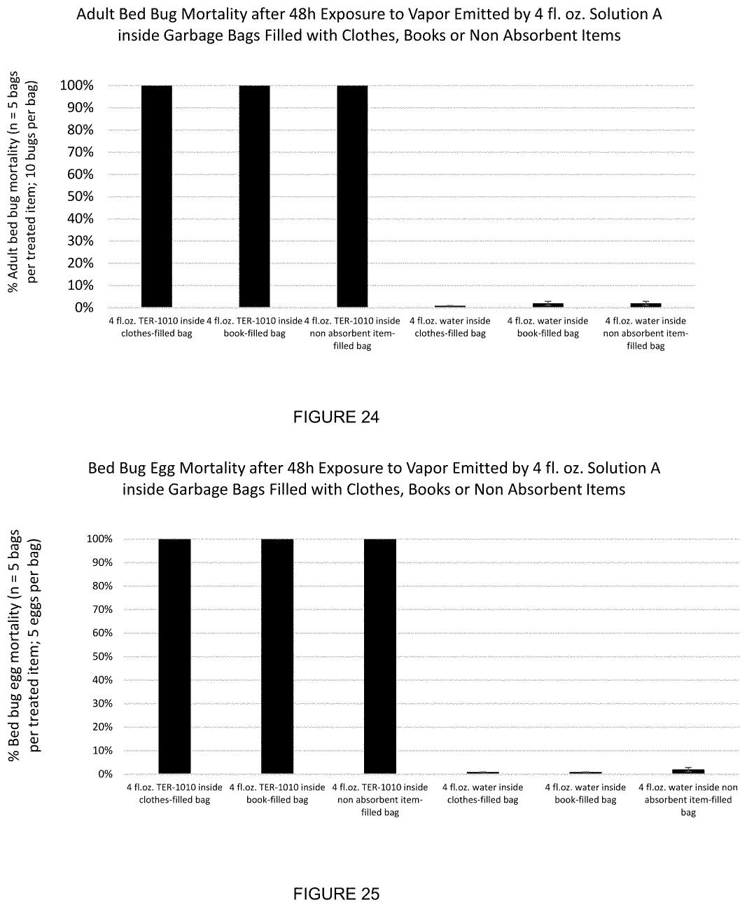

Adult bed bugs were observed for signs of toxicity and mortality at 48 hours after adult bed bugs were introduced to a 4 fluid oz. dose of pesticidal composition Solution A inside a sealed plastic garbage bag (approx. 40-60 US gallon size) containing either clothes, books, or non-adsorbent items (non-adsorbent household items such as electronics). As shown, in FIG. 24, at a 4 fluid oz. dose of Solution A, 100% adult bed bug mortality was observed at 48 hrs, indicating that pesticidal vapors emitted by Solution A can cause adult bed bug mortality, and that direct contact with treated surfaces are not necessary to induce mortality. A total of 5 garbage bags each infested with 10 adult bed bugs were tested for each treatment group in this example. As also shown in FIG. 24, a control dose of 4 oz of water inside equivalent sealed garbage bags containing clothes, books, or non-adsorbent items, was substantially not effective to kill adult bed bugs over the tested 48 hr interval.

### Example 1.6: Efficacy of Pesticidal Vapors from Pesticidal Composition Solution A Against Bed Bug Eggs on Garbage Bag-Enclosed Clothes, Books or Non-Adsorbent Items

Bed bug eggs were observed for signs of toxicity and mortality at 48 hours after bed bug eggs were introduced to a 4 fluid oz. dose of pesticidal composition Solution A inside a sealed plastic garbage bag (approx. 40-60 US gallon size) containing either clothes, books, or non-adsorbent items (non-adsorbent household items such as electronics). As shown, in FIG. 25, at a 4 fluid oz. dose of Solution A, 100% bed bug egg mortality was observed at 48 hrs, indicating that pesticidal vapors emitted by Solution A can cause bed bug egg mortality, and that direct contact with treated surfaces are not necessary to induce mortality. A total of 5 garbage bags each infested with 5 bed bug eggs were tested for each treatment group in this example. As also shown in FIG. 25, a control dose of 4 oz of water inside equivalent sealed garbage bags containing clothes, books, or non-adsorbent items, was substantially not effective to kill bed bug eggs over the tested 48 hr interval.

### Example 1.7: Efficacy of Pesticidal Vapors from Pesticidal Composition Solution A Against Adult Dust Mites on Garbage Bag-Enclosed Clothes, Books or Non-Adsorbent Items

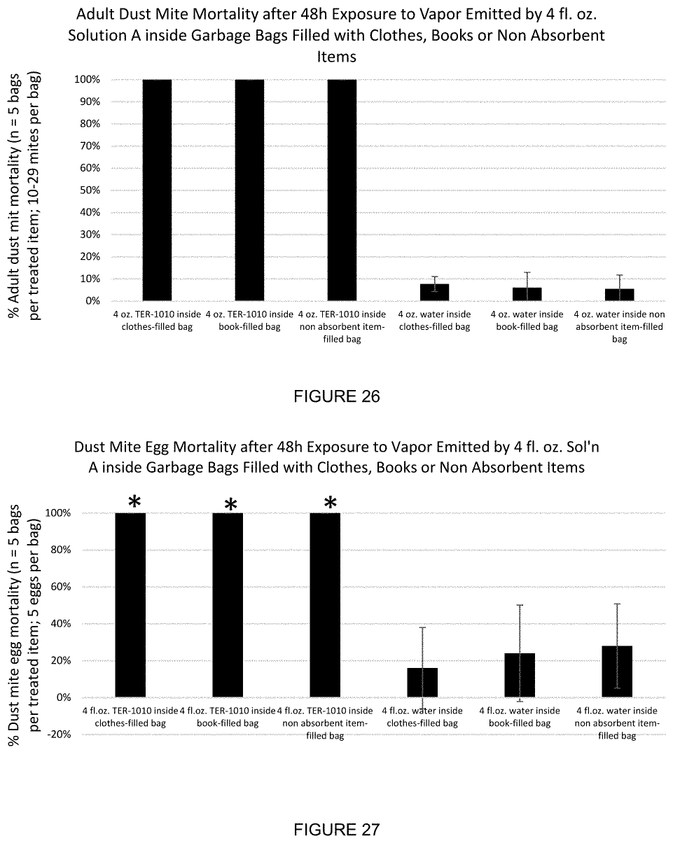

Adult dust mites were observed for signs of toxicity and mortality at 48 hours after adult dust mites were introduced to a 4 fluid oz. dose of pesticidal composition Solution A inside a sealed plastic garbage bag (approx. 40-60 US gallon size) containing either clothes, books, or non-adsorbent items (non-adsorbent household items such as electronics). As shown, in FIG. 26, at a 4 fluid oz. dose of Solution A, 100% adult dust mite mortality was observed at 48 hrs, indicating that pesticidal vapors emitted by Solution A can cause adult dust mite mortality, and that direct contact with treated surfaces are not necessary to induce mortality. A total of 5 garbage bags each infested with 10-29 adult dust mites were tested for each treatment group in this example. As also shown in FIG. 26, a control dose of 4 oz of water inside equivalent sealed garbage bags containing clothes, books, or non-adsorbent items, was substantially not effective to kill adult dust mites over the tested 48 hr interval.

### Example 1.8: Efficacy of Pesticidal Vapors from Pesticidal Composition Solution A Against Dust Mite Eggs on Garbage Bag-Enclosed Clothes, Books or Non-Adsorbent Items

Dust mite eggs were observed for signs of toxicity and mortality at 48 hours after dust mite eggs were introduced to a 4 fluid oz. dose of pesticidal composition Solution A inside a sealed plastic garbage bag (approx. 40-60 US gallon size) containing either clothes, books, or non-adsorbent items (non-adsorbent household items such as electronics). As shown, in FIG. 27, at a 4 fluid oz. dose of Solution A, 100% dust mite egg mortality was observed at 48 hrs, indicating that pesticidal vapors emitted by Solution A can cause dust mite egg mortality, and that direct contact with treated surfaces are not necessary to induce mortality. A total of 5 garbage bags each infested with 5 dust mite eggs were tested for each treatment group in this example. As also shown in FIG. 27, a control dose of 4 oz of water inside equivalent sealed garbage bags containing clothes, books, or non-adsorbent items, was substantially not effective to kill dust mite eggs over the tested 48 hr interval.

### Example 2: Exemplary Volatile Pesticidal Compositions Applied in an Enclosed Treatment Enclosure

The following examples utilize the following vapor forming pesticidal or pest control active compositions as shown in Table 2.0 below, administered using a dose of 4 fl. oz. inside a sealed, book-filled, 42 US gallon plastic bag to treat bed bug adults and eggs at exposures from 24 h to 5 days, which were found to result in 100% mortality of adult bed bugs and/or bed bug eggs within 5 days after exposure:

| Exemplary | Cold | | | | |
|---|---|---|---|---|---|
| Com- | Pressed | Ethoxylated | | Vapor | |
| position | Neem | Castor Oil | Solvent | Forming | Diluent |
| Reference | Oil | Emulsifier | Component | Carrier % | % |
| # | % (v/v) | % (v/v) | % (v/v) | (v/v) | (v/v) |
| TER-843 | 5.5% | 1.25% | 18.25% | 75% tert | n/a |
| | | | acetophenone | butyl | |
| | | | | acetate | |
| TER-837 | 5.5% | 1.25% | 18.25% | 75% | n/a |
| | | | acetophenone | dibasic | |
| | | | | ester | |
| TER-841 | 5.5% | 1.25% | 18.25% | 75% | n/a |
| | | | acetophenone | acetone | |
| TER-844 | 5.5% | 1.25% | 18.25% | 75% | n/a |
| | | | acetophenone | para- | |
| | | | | chloro- | |
| | | | | benzo- | |
| | | | | trifluoride | |
| TER-847 | 5.5% | 1.25% | 18.25% | 37.5% | 37.5% |
| | | | acetophenone | acetone | water |
| TER-845 | 5.5% | 1.25% | 18.25% | 75% | n/a |
| | | | acetophenone | methyl | |
| | | | | acetate | |
| TER-864 | 5.5% | 1.25% | 18.25% | 7.5% tert | 67.5% |
| | | | acetophenone | butyl | water |
| | | | | acetate | |
| TER-851 | 5.5% | 1.25% | 10% | 10% | 73.25% |
| | | | acetophenone | iso- | water |
| | | | | propanol | |
| TER-872 | 5.5% | 1.25% | n/a | 3% tert | 90.25% |
| | | | | butyl | propylene |
| | | | | acetate | glycol |
| TER-902 | 5.5% | 1.25% | n/a | 18% ethyl | 73.25% |
| | | | | acetate | propylene |
| | | | | | glycol |
| TER-903 | 5.5% | 1.25% | n/a | 18% | 73.25% |
| | | | | methyl | propylene |
| | | | | acetate | glycol |
| TER-836 | 5.5% | 1.25% | 18.25% | 75% | n/a |
| | | | acetophenone | benzyl | |
| | | | | alcohol | |
| TER-840 | 5.5% | 1.25% | 18.25% | 75% | n/a |
| | | | acetophenone | propylene | |
| | | | | glycol | |
| TER-849 | 5.5% | 1.25% | 18.25% | 7.5% | 67.5% |
| | | | acetophenone | acetone | benzyl |
| | | | | | alcohol |
| TER-842 | 5.5% | 1.25% | 18.25% | 75% | n/a |
| | | | acetophenone | ammonium | |
| | | | | carbonate | |
| TER-848 | 5.5% | 1.25% | 18.25% | 7.5% | 67.5% |
| | | | acetophenone | acetone | water |
| TER-865 | 5.5% | 1.25% | 18.25% | 17% para- | 58% |
| | | | acetophenone | chloro- | water |
| | | | | benzo- | |
| | | | | trifluoride | |
| TER-901 | 5.5% | 1.25% | n/a | 5% tert | 88.25% |
| | | | | butyl | propylene |
| | | | | acetate | glycol |
| TER-897 | 5.5% | 1.25% | n/a | 18% para- | 75.25% |
| | | | | chloro- | propylene |
| | | | | benzo- | glycol |
| | | | | trifluoride | |
| TER-872 | 5.5% | 1.25% | n/a | 3% tert | 90.25% |
| | | | | butyl | propylene |
| | | | | acetate | glycol |
| TER-858 | 5.5% | 1.25% | 1% acetone | 19% | 75.25% |
| | | | | iso- | water |
| | | | | propanol | |
| TER-857 | 5.5% | 1.25% | 1% acetone | 19% | 75.25% |
| | | | | iso- | propylene |
| | | | | propanol | glycol |
| TER-899 | 5.5% | 1.25% | 9% | 9% | 35.25% |
| | | | acetophenone | iso- | propylene |
| | | | | propanol | glycol/ |
| | | | | | 40% |
| | | | | | water |
| TER-900 | 5.5% | 1.25% | 4% | 14% | 75.25% |
| | | | acetophenone | iso- | propylene |
| | | | | propanol | glycol |

All experiments described below as examples 2.1-2.9 were conducted at room temperature (approximately 21±2° C.). Without being bound by theory, changes in temperature may affect the release of vapor from the pesticidal or pest control active composition, so lower concentrations may be effective at higher temperatures, and higher concentrations may be required at lower ambient temperatures. Based on experiments conducted by the inventors, the compositions tested in these examples maintain efficacy at temperatures of 15° C. or higher, and can reasonably be expected to remain effective at lower temperatures, although higher treatment concentrations may be required at lower temperatures.

### Example 2.1: Efficacy of Pesticidal Vapors from Exemplary Pesticidal Compositions TER-836, 837, 840, 841, 842, 843, 844, 845, 847, 848, 849, and 851 Against Adult Bed Bugs on Books Enclosed in a 42 US Gal. Plastic Bag

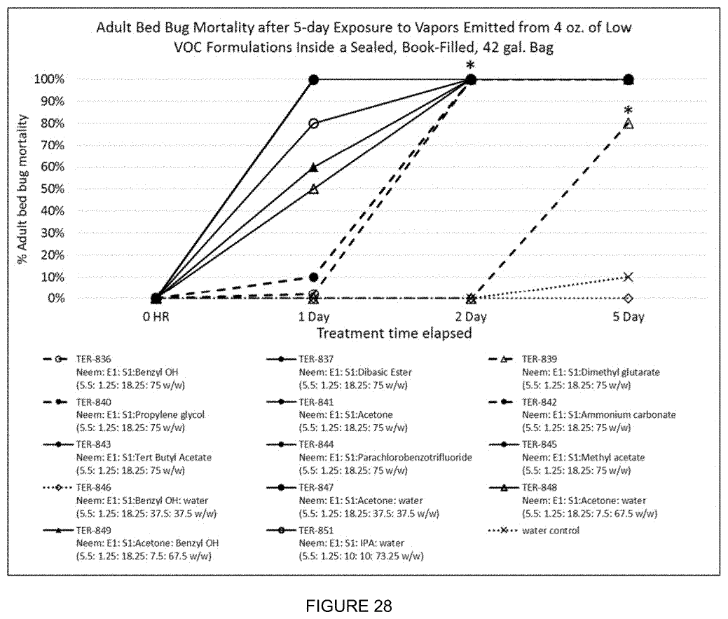

Adult bed bugs were observed for signs of toxicity and mortality at 1 d (24 h), 2 d (48 h) and 5 d after adult bed bugs were introduced to a 4 fluid oz. dose of one of 14 exemplary pesticidal compositions, inside a sealed 42 US gal. plastic bag containing books. As shown, in FIG. 28, at a 4 fluid oz. dose of the exemplary pesticidal compositions, 100% adult bed bug mortality was observed at 48 hrs for each of the following exemplary pesticidal compositions: TER-836, 840, 843, 849, 837, 841, 844, 847, 851, 842, 845 and 848, indicating that pesticidal vapors emitted by each of these exemplary pesticidal compositions comprising at least neem oil, ethoxylated castor oil emulsifier, and a vapor forming carrier component, can cause adult bed bug mortality within 48 hrs after exposure, and that direct contact with treated surfaces are not necessary to induce mortality. Additionally, a 4 fl. oz dose of pesticidal composition TER-843 was also found to result in 100% mortality of the adult bed bugs within 24 hrs.

A total of 10 adult bed bugs were introduced inside each sealed plastic bag of books for each treatment in this example 2.1. As also shown in FIG. 28, a control dose of 4 fl. oz. of water inside an equivalent sealed garbage bag containing books, was substantially not effective to kill adult bed bugs over the tested 48 hr interval. Additionally, exemplary compositions TER-846 (containing 5.5% neem oil, 1.25% ethoxylated castor oil emulsifier, 18.25% acetophenone, 37.5% benzyl alcohol and 37.5% water) and TER-839 (containing 5.5% neem oil, 1.25% ethoxylated castor oil emulsifier, 18.25% acetophenone, and 75% dimethyl glutarate) were also not effective to kill 100% of the bed bug adults within 5 days.

### Example 2.2: Efficacy of Pesticidal Vapors from Exemplary Pesticidal Compositions TER-836, 837, 839, 840, 841, 843, 844, 845, 847, 848, 849, and 851 Against Bed Bug Eggs on Books Enclosed in a 42 US Gal. Plastic Bag

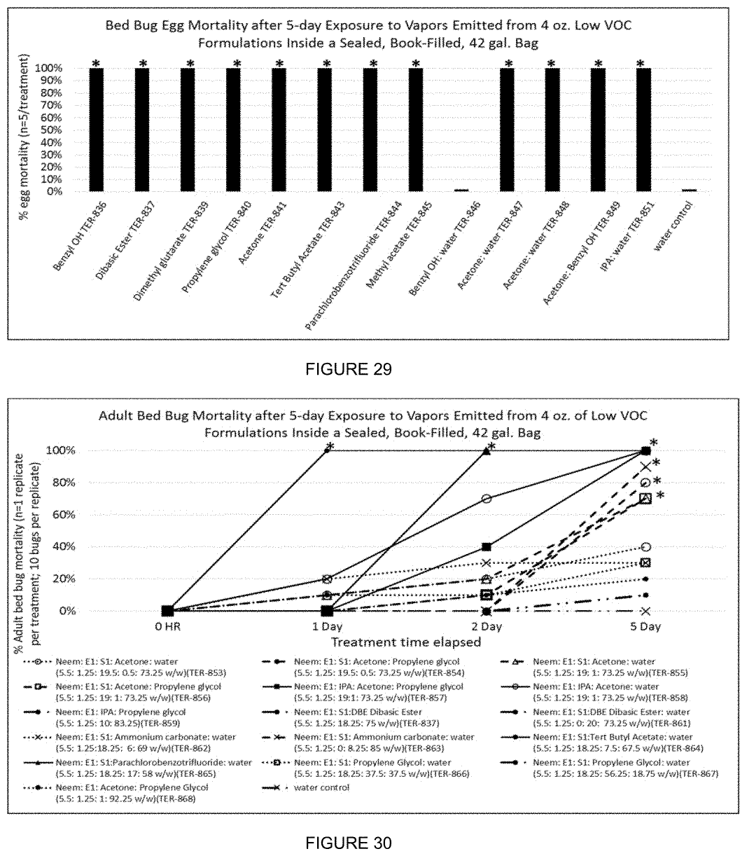

Bed bug eggs were observed for signs of toxicity and mortality at 5 d after the bed bug eggs were introduced to a 4 fluid oz. dose of one of 12 exemplary pesticidal compositions, inside a sealed 42 US gal. plastic bag containing books. As shown, in FIG. 29, at a 4 fluid oz. dose of the exemplary pesticidal compositions, 100% bed bug egg mortality was observed at 5 days for each of the following exemplary pesticidal compositions: TER-836, 837, 839, 840, 841, 843, 844, 845, 847, 848, 849 and 851, indicating that pesticidal vapors emitted by each of these exemplary pesticidal compositions comprising at least neem oil, ethoxylated castor oil emulsifier, and a vapor forming carrier component, can cause bed bug egg mortality within 5 days after exposure, and that direct contact with treated surfaces are not necessary to induce mortality.

A total of 5 bed bug eggs were introduced inside each sealed plastic bag of books for each treatment in this example 2.2. As also shown in FIG. 29, a control dose of 4 fl. oz. of water inside an equivalent sealed garbage bag containing books, was substantially not effective to kill adult bed bugs over the tested 5 day interval. Additionally, exemplary composition TER-846 (containing 5.5% neem oil, 1.25% ethoxylated castor oil emulsifier, 18.25% acetophenone, 37.5% benzyl alcohol and 37.5% water) was also not effective to kill 100% of the bed bug eggs within 5 days.

### Example 2.3: Efficacy of Pesticidal Vapors from Exemplary Pesticidal Compositions TER-864, 865, 858, and 857 Against Adult Bed Bugs on Books Enclosed in a 42 US Gal. Plastic Bag

Adult bed bugs were observed for signs of toxicity and mortality at 1 d (24 h), 2 d (48 h) and 5 d after adult bed bugs were introduced to a 4 fluid oz. dose of one of 4 exemplary pesticidal compositions, inside a sealed 42 US gal. plastic bag containing books. As shown, in FIG. 30, at the tested 4 fluid oz. dose of the exemplary pesticidal compositions, 100% adult bed bug mortality was observed at 5 days after exposure for each of the following tested exemplary pesticidal compositions including: TER-864, 865, 858 and 857, indicating that pesticidal vapors emitted by each of these exemplary pesticidal compositions comprising at least neem oil, ethoxylated castor oil emulsifier, and a vapor forming carrier component, can cause adult bed bug mortality within 5 days after exposure, and that direct contact with treated surfaces are not necessary to induce mortality. Additionally, a 4 fl. oz. dose of pesticidal composition TER-865 was also found to result in 100% mortality of the adult bed bugs within 48 hrs after exposure. A 4 fl. oz. dose of the pesticidal composition TER-864 was also found to result in 100% mortality of the adult bed bugs within only 24 hrs after exposure.

A total of 10 adult bed bugs were introduced inside each sealed plastic bag of books for each treatment in this example 2.3. As also shown in FIG. 30, a control dose of 4 fl. oz. of water inside an equivalent sealed garbage bag containing books, was substantially not effective to kill adult bed bugs over the tested 5 day interval. Additionally, exemplary compositions TER-867 (containing 5.5% neem oil, 1.25% ethoxylated castor oil emulsifier, 18.25% acetophenone, 56.25% propylene glycol and 18.75% water), and TER-868 (containing 5.5% neem oil, 1.25% ethoxylated castor oil emulsifier, 1% acetone, and 92.25% propylene glycol) were also substantially not effective to kill adult bed bugs within 5 days. Exemplary compositions TER-866, 862, and 853 were also not effective to kill adult bed bugs within 5 days, and resulted in killing of less than 40% of adult bedbugs within a 5 day period. Exemplary compositions TER-856, 855, 863, 854 were effective to kill between 70-90% of adult bed bugs within 5 days, but were not effective to kill 100% of adult bedbugs within 5 days.

### Example 2.4: Efficacy of Pesticidal Vapors from Exemplary Pesticidal Compositions TER-854, 855, 856, 857, 858, 864 and 865 Against Bed Bug Eggs on Books Enclosed in a 42 US Gal. Plastic Bag

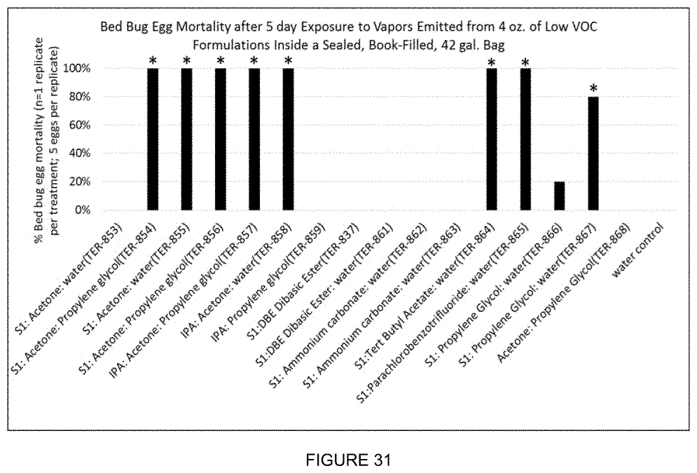

Bed bug eggs were observed for signs of toxicity and mortality at 24 h (1 d), 48 h (2 d), and 5 d after the bed bug eggs were introduced to a 4 fluid oz. dose of one of 16 exemplary pesticidal compositions, inside a sealed 42 US gal. plastic bag containing books. As shown, in FIG. 31, at a 4 fluid oz. dose of the exemplary pesticidal compositions, 100% bed bug egg mortality was observed at 5 days for each of the following exemplary pesticidal compositions: TER-854, 855, 856, 857, 858, 864 and 865, indicating that pesticidal vapors emitted by each of these exemplary pesticidal compositions comprising at least neem oil, ethoxylated castor oil emulsifier, and a vapor forming carrier component, can cause bed bug egg mortality within 5 days after exposure, and that direct contact with treated surfaces are not necessary to induce mortality.

A total of 5 bed bug eggs were introduced inside each sealed plastic bag of books for each treatment in this example 2.4. As also shown in FIG. 31, a control dose of 4 fl. oz. of water inside an equivalent sealed garbage bag containing books, was not effective to kill adult bed bugs over the tested 5 day interval. Additionally, exemplary compositions TER-853, 859, 837, 861, 862, 863, 866, and 868 were also substantially not effective to kill the bed bug eggs within 5 days. Exemplary composition TER-867 was found to be effective to kill approximately 80% of the bed bug eggs within 5 days.

In some embodiments, any of the exemplary pesticidal compositions disclosed above may be used in connection any of the above-described suitable vapor enclosure and release devices or apparatus, which may be operable to contain the pesticidal composition and release the pesticidal composition in an enclosed treatment space as a pesticidal vapor, such as for killing or controlling one or more pests. In some other embodiments, any of the exemplary pesticidal compositions disclosed above may alternatively be used in connection with any other suitable vapor enclosure and release device or apparatus which is adapted to contain the pesticidal composition and release it as a pesticidal vapor, such as for killing or controlling one or more pest.

While a number of exemplary aspects and embodiments have been discussed above, those of skill in the art will recognize certain modifications, permutations, additions and sub-combinations thereof. To the extent that they are not mutually exclusive, embodiments described above can be combined with one another to yield further embodiments of the invention. It is therefore intended that the following appended claims and claims hereafter introduced are not to be limited by the exemplary embodiments set forth herein, but are to be given the broadest interpretation consistent with the specification as a whole.

What is claimed is:

1. A device for releasing vapors of at least one of a pesticidal and a pest control composition, the device comprising a substrate impregnated with the composition, an impermeable housing containing the substrate, wherein the housing comprises one or more apertures adapted for releasing vapors from the substrate, wherein the composition comprises at least one pesticidal or pest control active ingredient, a surfactant or emulsifier, and a vapor forming carrier component, and wherein said composition is effective to form pesticidal or pest control vapors comprising said at least one pesticidal or pest control active ingredient; wherein said vapor forming carrier component comprises at least one component selected from the list comprising: methyl acetate, ethyl acetate, tert butyl acetate, benzyl alcohol, dibasic ester, dimethyl glutarate, acetone, acetophenone, parachlorobenzotrifluoride, ammonium carbonate, methanol, Zemasol™ and combinations thereof.

2. The device according to claim 1 wherein said composition additionally comprises a polar aromatic solvent.

3. The device according to claim 1 wherein said composition additionally comprises at least one diluent.

4. The device according to claim 1 wherein said at least one pesticidal or pest control active ingredient comprises at least one pesticidal natural oil.

5. The device according to claim 2, wherein said at least one pesticidal natural oil comprises neem oil.

6. The device according to claim 1, wherein said apertures comprise at least one regular pattern of apertures defining an opening or window in said housing adapted for release of said vapors.

7. A treatment enclosure for controlling at least one species of pest infecting an article, the treatment enclosure comprising:
a device for releasing vapors of at least one of a pesticidal and a pest control composition according to claim 1; and
a structure for fully or partially sealing the treatment enclosure, to contain pesticidal or pest control vapors released by the device within the treatment enclosure.

8. The treatment enclosure according to claim 7, wherein said composition comprises at least one pesticidal natural oil, a surfactant or emulsifier, and a vapor forming carrier component.

9. The treatment enclosure according to claim 7 wherein said composition additionally comprises at least one diluent.

10. The treatment enclosure according to claim 7 wherein said vapor forming carrier component comprises at least one component selected from the list comprising: methyl acetate, ethyl acetate, tert butyl acetate, benzyl alcohol, dibasic ester, dimethyl glutarate, acetone, acetophenone, parachlorobenzotrifluoride, ammonium carbonate, methanol, Zemasol™ and combinations thereof.

11. The treatment enclosure according to claim 8, wherein said composition additionally comprises a polar aromatic solvent.

12. The treatment enclosure according to claim 7, wherein the structure comprises:
an outer layer that is impermeable or substantially impermeable to pesticidal vapors, wherein the outer layer comprises a plastic bag or a rigid container adapted to resist said pesticidal vapors; and
a resealable opening or cover for allowing a user to insert and remove infested articles from the treatment enclosure.

13. A method of controlling at least one pest, the method comprising:
providing a treatment enclosure containing at least one article infested with at least one pest or their eggs, and at least one device for releasing vapors of at least one of a pesticidal and a pest control composition according to claim 1; and
releasing at least one of pesticidal and pest control vapors from the at least one device within the treatment enclosure; and
containing the vapors within the treatment enclosure for a treatment period.

14. The method according to claim 13, wherein said composition comprises at least one pesticidal natural oil, a surfactant or emulsifier, and a vapor forming carrier component.

15. A pesticidal composition for killing pests, the composition comprising between 0.25% and 75% of a pesticidal natural oil, between 0.1% and 15% of a surfactant, and between 2% and 75% of a vapor forming carrier, wherein said composition is adapted to produce pesticidal vapors comprising said pesticidal natural oil and said vapor forming carrier; wherein said vapor forming carrier component comprises at least one component selected from the list comprising: methyl acetate, ethyl acetate, tert butyl acetate, benzyl alcohol, dibasic ester, dimethyl glutarate, acetone, acetophenone, parachlorobenzotrifluoride, ammonium carbonate, methanol, Zemasol™ and combinations thereof.

16. The pesticidal composition according to claim 15, wherein said composition additionally comprises a polar aromatic solvent.

17. The pesticidal composition according to claim 15, wherein said polar aromatic solvent comprises an aryl ketone.

18. The pesticidal composition according to claim 15, wherein said pests comprise at least one of arthropods and nematodes.

19. The device according to claim 15, wherein said pesticidal natural oil comprises neem oil.
